(19) United States
(12) Patent Application Publication
(10) Pub. No.: US 2003/0138655 A1
(43) Pub. Date: Jul. 24, 2003

(54) Wiper blade

(76) Inventors: Jiro Watanabe, Kanagawa (JP); Masuo Kuroda, Kanagawa (JP); Naoyuki Ooka, Kanagawa (JP); Noboru Ishida, Saitama (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/148,337

(22) PCT Filed: Nov. 29, 2000
(86) PCT No.: PCT/JP00/08433

(30) Foreign Application Priority Data
Nov. 29, 1999 (JP) 11/338307
Nov. 29, 1999 (JP) 11/338308
Sep. 8, 2000 (JP) 2000-272878
Sep. 20, 2000 (JP) 2000-285105
Sep. 20, 2000 (JP) 2000-285337

(51) Int. Cl. B32B 27/00

(52) U.S. Cl. 428/523; 156/244.11; 428/500; 428/411.1

(57) ABSTRACT

A wiper blade which is prepared by one-piece molding of a wiper base material comprising a thermoplastic elastomer composition comprising a thermoplastic resin and a dynamically vulcanized elastomer component and having a structure wherein the dynamically vulcanized elastomer component is dispersed in a continuous phase comprised of the thermoplastic resin, and a reinforcing material. The wiper blade is advantageous in that it is excellent in wiping property and also durability, the occurrence of chattering noise is expressed, and it needs a reduced number of steps for assembly. The use of the wiper base material has allowed the preparation of a wiper blade having such excellent characteristics by the use of one-piece molding.

### TECHNICAL FIELD

This invention relates to a wiper blade which may be used on front, rear, and other windshields of vehicles such as automobiles and trains, ships, aircraft, and the like, and more specifically, this invention relates to a wiper blade produced by integrally molding a base and a reinforcement.

### BACKGROUND ART

Vehicles such as automobiles and trains, aircraft, and ships are provided with a wiper on their front and rear windshields and other surfaces (hereinafter simply referred to as the “glass surface”) to wipe and remove the rain water, mud water, sea water, ice, snow, dirt, and the like so that clear vision is secured for driving safety.

A wiper blade which is the part of the wiper that becomes in contact with the glass surface is required to have sufficient wiping capability of the glass surface, to have durability that prevents wearing and cracks, to be free of chattering sound (sound associated with stick slip) caused by the friction between the glass and the wiper blade, and to have a rigidity of some extent.

The materials known for use in such wiper blade include natural rubber; synthetic rubbers such as ethylene-propylene-diene rubber (EPDM), chloroprene rubber (CR), and acrylonitrile-butadiene rubber (NBR); polyester thermoplastic elastomer (TPE); and the like. Among such rubber materials, a vulcanized polymer, and in particular, a vulcanized natural rubber is most often employed to reliably realize the wiping performance, durability, suppression of chattering noise, and other desired properties.

Of the conditions required for the wiper blade as described above, occurrence of the chattering can be eliminated by reducing the friction of the wiper blade surface that becomes in contact with the glass. Such reduction of the friction with the glass had been realized by treating the rubber surface with a halogen (chlorine) for surface hardening to thereby reduce the friction. Such hardening of the surface by halogen treatment, however, leads to an increase in the number of processing operations, and durability of the resulting wiper blade was insufficient although the treatment was effective in improving the lubricity, wiping performance, and suppression of the chattering.

Also known are wiper blades wherein a fluororesin coating layer comprising polyvinylidene fluoride or the like had been provided on the surface in order to improve the long term durability. Such wiper blades, however, exhibited inferior wiping performance as well as insufficient durability although chattering noise had been suppressed.

A metal or resin reinforcement has also been incorporated in the base of the rubber material as described above to secure rigidity of the wiper blade and improve the wiping performance. The blade of such composite structure has been produced by preliminarily forming the base component from a vulcanized rubber material by press molding, and thereafter inserting a steel reinforcement in the slit formed in the interior of the base. Accordingly, the production process of such conventional wiper blade required an assembly step of the body and the reinforcement, and simplification of the production procedure had been desired. The vulcanized high molecular weight rubber material as mentioned above is insufficient in flowability, and it has been difficult to integrally mold the rubber material and the reinforcement by co-extrusion.

Integral molding of a wiper blade by injection molding a resin or a thermoplastic elastomer composition by using the reinforcement as a core material has also been proposed (JP-A 9-39743 and the like). The resin or the thermoplastic elastomer composition used for the injection molding, however, is quite hard, and the wiper blade obtained by such injection molding exhibits inferior wiping performance as well as insufficient long term durability. When the wiper blade is produced by using an olefin polyester elastomer for the base material, the resulting wiper blade is free from chattering noise and sufficient in durability. Such wiper blade, however, exhibits inferior initial wiping performance due to the hardness of the material itself.

In view of the situation as described above, there is a demand for the development a wiper blade which is produced by integrally molding the base and the reinforcement, and which fulfils various properties desired for a wiper blade such as wiping performance, suppression of the chattering noise, and durability.

### DISCLOSURE OF THE INVENTION

In view of the prior art situation as described above, the inventors of the present invention have made an intensive investigation, and found that a wiper blade having the desired properties can be produced by integrally molding a thermoplastic elastomer composition with a reinforcement when the thermoplastic elastomer composition contains a thermoplastic resin and a dynamically vulcanized elastomer component at a predetermined formulation so that a sea/island structure with the elastomer component dispersed in the thermoplastic resin matrix will be formed, and all of the objects as described above will be realized in such a wiper blade. The present invention has been completed on the basis of such finding. Also provided by the present invention are a wiper blade wherein deflection due to the integral molding has been avoided, and a wiper blade having edge structure which suppresses chattering noise and improves the wiping performance and durability.

The wiper blade according to the first aspect of the present invention is as described below.

(1) A wiper blade produced by integrally molding a thermoplastic elastomer composition and a reinforcement, wherein the thermoplastic elastomer composition comprises a thermoplastic resin and a dynamically crosslinked elastomer component, and the thermoplastic elastomer composition has a structure wherein the dynamically crosslinked elastomer component is dispersed in a continuous phase of the thermoplastic resin.

(2) The thermoplastic elastomer composition preferably contains the thermoplastic resin and the elastomer component at a weight ratio (thermoplastic resin/elastomer component) of 85/15 to 15/85.

(3) The thermoplastic resin preferably has a melting point of 200° C. or higher.

(4) In the method for producing the wiper blade of the present invention, the thermoplastic elastomer composition and the reinforcement are integrally molded by co-extrusion.

It was also found that an integrally molded wiper blade occasionally suffers from deflection although rigidity of desired level can be obtained. A wiper blade with deflection suffers from poor wiping performance irrespective of the direction of the deflection. The inventors particularly investigated integral molding which does not induce such deflection, and it was then found that curving coefficient which can be calculated from Young's modulus and shrinkage may be used as an index, and that a molded article free from deflection can be produced from a thermoplastic elastomer composition and a reinforcement by maintaining this curving coefficient equal to or below a certain value. It was also found that when the thermoplastic elastomer composition and the reinforcement are combined so that the resulting wiper blade has the curving coefficient of certain value and the predetermined rigidity, a wiper blade can be integrally molded to have the desired properties, and in particular to have the desired wiping performance without suffering from the deflection. It is to be noted that the curving coefficient is a parameter which had been proposed in the technology of metal composite material, namely, in the bimetal technology. It is also to be noted that distortion can be used as an index for the rigidity of the wiper blade.

The wiper blade according to the second aspect of the present invention is as described below.

(5) A wiper blade which is an integrally molded article comprising a base made of a thermoplastic elastomer composition and a reinforcement, and which satisfies the following characteristics (1) and (2).

(1) When said thermoplastic elastomer composition and said reinforcement has a Young's modulus of E₁ and E₂, respectively; difference in shrinkage between the material used for said thermoplastic elastomer composition and said reinforcement is δᵣ; and said wiper blade is regarded as a bilayer structure substantially comprising a base layer of the thermoplastic elastomer composition and a reinforcement layer,

curving coefficient K determined by the following formula is up to 1×10⁻³

K=2δᵣ/[3+{(1+mn)(1+mn³)/mn(1+n)²}] (i)

wherein

δᵣ represents difference in the shrinkage between the base and the reinforcement;

m represents E₁/E₂ (wherein E₁ is Young's modulus of the base, and E₂ is Young's modulus of the reinforcement); and

n represents h₁/h₂ (wherein h₁ is thickness of the base, and h₂ is thickness of the reinforcement).

(2) When the wiper blade has a length of 200 mm and a concentrated load of 50 g is placed at one end, the wiper blade exhibits a distortion in the range of 20 to 80 mm.

(6) A wiper blade according to the above (5) wherein said thermoplastic elastomer composition comprises a thermoplastic resin and a dynamically crosslinked elastomer component, and said thermoplastic elastomer composition has a structure wherein the dynamically crosslinked elastomer component is dispersed in a continuous phase of the thermoplastic resin.

(7) A method for producing the wiper blade of the above (5) or (6) wherein the thermoplastic elastomer composition and the reinforcement that have been selected to satisfy the above (1) and (2) are integrally molded by co-extrusion.

The wiper blade according to the third aspect of the present invention is as described below.

(8) A wiper blade comprising a body and a surface coating layer which covers at least edge surface of said body, wherein at least said body comprises a thermoplastic elastomer composition which comprises a thermoplastic resin and a dynamically crosslinked elastomer component, and which has a structure wherein the dynamically crosslinked elastomer component is dispersed in a continuous phase of the thermoplastic resin.

(9) The surface coating layer preferably has a melting point of 200° C. or higher.

(10) A wiper blade according to the above (8) or (9) wherein said surface coating layer comprises a thermoplastic elastomer composition which comprises a thermoplastic resin and a dynamically crosslinked elastomer component, and which has a structure wherein the dynamically crosslinked elastomer component is dispersed in a continuous phase of the thermoplastic resin.

(11) A wiper blade according to any one of the above (8) to (10) wherein said body has a hardness (JIS-A) of 50 to 80, and said surface coating layer has a hardness (JIS-A) of 70 to 99.

(12) A method for producing a wiper blade of any one of the above (8) to (11) wherein the materials used for said body and the material used for said surface coating layer are integrally molded by co-extrusion.

The fourth aspect of the present invention is as described below.

(13) A wiper blade comprising at least a body made of a thermoplastic elastomer composition and an edge made of a thermoplastic elastomer composition or a thermoplastic resin wherein at least the surface of said edge which becomes in contact with glass has a ten point average roughness of 2 to 50 μm.

(14) A wiper blade according to the above (13) wherein at least the part of said edge which becomes in contact with glass comprises a material containing 3 to 50 vol % of a filler having an average particle size of up to 40 μm.

(15) A wiper blade according to the above (14) wherein said filler is graphite, molybdenum disulfide, polyethylene tetrafluoride, or glass beads.

(16) A wiper blade according to any one of the above (13) to (15) wherein said body comprises a thermoplastic elastomer composition which comprises a thermoplastic resin and a dynamically crosslinked elastomer component, and which has a structure wherein the dynamically crosslinked elastomer component is dispersed in a continuous phase of the thermoplastic resin.

(17) A wiper blade according to any one of the above (13) to (16) wherein said edge comprises a thermoplastic elastomer composition which comprises a thermoplastic resin and a dynamically crosslinked elastomer component, and which has a structure wherein the dynamically crosslinked elastomer component is dispersed in a continuous phase of the thermoplastic resin.

(18) A wiper blade according to any one of the above (13) to (17) produced by co-extruding the material of said body and the material of said edge.

### BRIEF DESCRIPTION OF THE DRAWINGS

FIG. 1 is a cross sectional view of the wiper blade according to an embodiment of the present invention.

FIG. 2 is a cross sectional view of the wiper blade according to another embodiment of the present invention.

FIG. 3 is a cross sectional view of the wiper blade according to a further embodiment of the present invention.

FIGS. 4(a) to (d) are transverse cross sectional views of the wiper blade according to further embodiments of the present invention.

FIGS. 5(a) to (d) are longitudinal cross sectional views of the wiper blade according to further embodiments of the present invention.

FIGS. 6(a) to (j) are transverse cross sectional views illustrating various embodiments of the reinforcement in the wiper blade of the present invention.

FIGS. 7(a) to (j) are transverse cross sectional views illustrating various embodiments of the reinforcement in the wiper blade of the present invention.

FIG. 8 is a cross sectional view of the wiper blade according to an embodiment of the present invention.

FIG. 9 is a schematic cross sectional view of the wiper blade used in the present invention to determine the curving coefficient of the wiper blade.

FIG. 10 is a view illustrating the stress applied in FIG. 9.

FIG. 11 is a view illustrating the deflection.

FIG. 12 is a cross sectional view of the wiper blade according to an embodiment of the present invention wherein edge of the blade is coated with a surface coating layer.

FIG. 13 is a cross sectional view of the wiper blade according to another embodiment of the present invention wherein the blade edge is coated with a surface coating layer.

FIG. 14 is a cross sectional view of the wiper blade according to further embodiment of the present invention wherein the blade edge is coated with a surface coating layer.

### BEST MODE FOR CARRYING OUT THE INVENTION

Next, the present invention is described in detail.

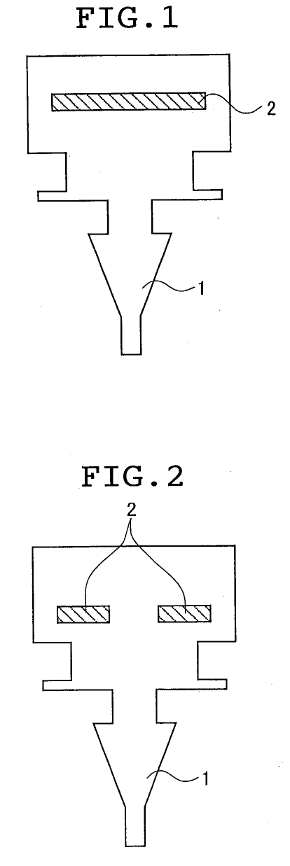

The wiper blade according to the first aspect of the present invention is described by referring to the transverse cross section schematically illustrated in FIG. 1. In FIG. 1, the bottom side (bottom side of the sheet) is the side that becomes in contact with the glass. In FIG. 1, the material of the base 1 (hereinafter also referred to as the base) and the reinforcement 2 have been integrally molded.

In the present invention, a thermoplastic elastomer composition is used for the base 1. This thermoplastic elastomer composition comprises a thermoplastic resin and a dynamically crosslinked elastomer component, and the thermoplastic elastomer composition has a structure wherein the dynamically crosslinked elastomer component is dispersed in a continuous phase of the thermoplastic resin. First, the thermoplastic resin (or the resin component) and the elastomer component constituting this particular thermoplastic elastomer composition is described.

<Resin Component>

The resin component used may be selected from a wide variety of thermoformable thermoplastic resins that are known in the art. Typical such resins include polyolefin resins, for example, high density polyethylene (HDPE), low density polyethylene (LDPE), ultra high molecular weight polyethylene (UHMWPE), isotactic polypropyrene, syndiotactic polypropyrene and other polypropyrenes (PP), and ethylene-propylene copolymer resin; polyamide resins, for example, Nylon 6(N6), Nylon 66(N66), Nylon 46(N46), Nylon 11(N11), Nylon 12(N12), Nylon 610(N610), Nylon 612(N612), Nylon 6/66 copolymer (N6/66), Nylon 6/66/610 copolymer (N6/66/610), Nylon MXD6(MXD6), Nylon 6T, Nylon 6/6T copolymer, Nylon 66/PP copolymer, and Nylon 66/PPS copolymer; polyester resins, for example, polybutylene terephthalate (PBT), polyethylene terephthalate (PET), polyethylene isophthalate (PEI), polyester copolymer, PET/PEI copolymer, polyarylate (PAR), polybutylene naphthalate (PBN), liquid crystal polyester, polyoxy-alkylenediimidic acid-polybutylate terephthalate copolymer and other aromatic polyesters; polyether resins, for example, polyacetal (POM), polyphenylene oxide (PPO), polysulfone (PSF), polyetherketone (PEEK); polynitrile resins, for example, polyacrylnitrile (PAN), polymethacrylnitrile, acrylnitrile/styrene copolymer (AS), methacrylnitrile/styrene copolymer, and methacrylnitrile/styrene/-butadiene copolymer; polymethacrylate resins, for example, polymethyl polymethacrylate (PMMA), and polyethyl polymethacrylate; polyvinyl resins, for example, vinyl acetate (EVA), polyvinyl alcohol (PVA), vinyl alcohol/ethylene copolymer (EVOH), polyvinylidene chloride (PVDC), polyvinyl chloride (PVC), vinyl chloride/vinylidene chloride copolymer, and vinylidene chloride/methylacrylate copolymer; cellulose resins, for example, cellulose acetate, and cellulose acetate butyrate; fluororesins, for example, polyvinylidene fluoride (PVDF), polyvinyl fluoride (PVF), polychlorofluoroethylene (PCTFE), and tetrafluoroethylene/ethylene copolymer (ETFE)); imide resins, for example, aromatic polyimide (PI); and polyacetal.

So called thermoplastic elastomer (TPE) constituted from the hard segment of a crystalline thermoplastic resin and the amorphous soft segment may also be used for the resin component. Typical examples of such elastomer include TPE such as polyurethane elastomers, polyester elastomers, fluoropolymer elastomers, and polyamide elastomers.

Typical polyurethane elastomers include those having the hard segment of a short chain glycol isocyanate and the soft segment of a long chain polyol; and those comprising the hard segment rich in urethane and urea bond and the soft segment mainly comprising a polyether. Typical polyester elastomers include those having the hard segment of polybutylene terephthalate and the soft segment of a long chain polyol or a polyester. Typical fluoropolymer elastomers include those having the hard segment of a fluororesin component and the soft segment of a fluororubber component. Typical polyamide elastomers include those having the hard segment of Nylon and the soft segment of polytetramethylene glycol.

Among these, the preferred are polypropyrene (PP), polyamide resin, polyester resin, polyether resin, fluororesin, polyamide elastomer, polyurethane elastomer, polyester elastomer (COPE), and the like in view of the cost, the frictional coefficient, and the melting point.

The resins as mentioned above for the resin component may be used either alone or in combination of two or more, or as a resin mixture containing such resins.

Among those mentioned above, use of a resin having the melting point of 200° C. or higher is preferable. As will be described below, the resin component as described above forms the continuous phase (matrix) in the molded wiper blade base. In other words, the surface of the blade substantially comprises the resin component. In the use of a wiper blade, there are occasions when the wiping is continued with no moisture left on the glass surface, for example, in the case of snow or in the tunnel. When the material used for the wiper blade has a low melting point, the melting is likely to occur at the surface of the wiper blade in contact with the glass surface, and the wiper blade is likely to stick to the glass surface to detract from sliding properties. Even if such wiping of the dry glass surface is continued for a prolonged period, the blade is prevented from melting by the frictional heat if the surface of the wiper blade has a melting point of 200° C. or higher.

<Elastomer Component>

The elastomer component may be the elastomer as described below, a mixture thereof, or a mixture containing such elastomers.

Exemplary elastomers include diene rubbers and hydrogenated products thereof, for example, NR, IR, epoxidated natural rubber, SBR, BR (High cis BR and low cis BR), NBR, hydrogenated NBR, and hydrogenated SBR; olefin rubbers, for example, ethylene-propylene-diene rubber (EPDM), EPM and other ethylene-propylene rubbers, maleic modified ethylene-propylene rubber (M-EPM), IIR, copolymer of isobutylene with an aromatic vinyl or diene monomer, acrylic rubber (ACM), and ionomer; halogen-containing rubbers, for example, Br-IIR, CI-IIR, brominated isobuthylene-paramethylstyrene copolymer (Br-IPMS), CR, hydrin rubber (CHR), chlorosulfonated polyethylene (CSM), chlorinated polyethylene (CM), and maleic modified chlorinated polyethylene (M-CM); silicone rubbers, for example, methylvinylsilicone rubber, dimethylsilicone rubber, and methylphenylvinylsilicone rubber; sulfur-containing rubber, for example, polysulfide rubber; fluororubbers, for example, vinylidene fluoride rubber, fluorine-containing vinylether rubber, tetrafluoroethylene-propylene rubber, fluorine-containing silicone rubber, and fluorine-containing phosphazene rubber; urethane rubbers; epichlorohydrine rubbers; thermoplastic elastomers, for example, styrene elastomer, olefin elastomer, ester elastomer, urethane selastomer, and polyamide elastomer.

Among these, the preferred are acrylic rubber (ACM), ethylene-propylene-diene rubber (EPDM), and other olefin rubbers, diene rubbers and hydrogenated products thereof, halogen-containing rubbers, fluororubbers, urethane rubbers, and epichlorohydrine rubbers in view of the cost, the weatherability, and the chemical resistance.

These elastomers may be used either alone or in combination or two or more.

<Thermoplastic Elastomer Composition>

In producing the thermoplastic elastomer composition from the resin component and the elastomer component as described above, the combination of the resin component and the elastomer component is not particularly limited, and at least one resin component arbitrarily selected from those described above may be used in combination with at least one elastomer arbitrarily selected from those described above.

The resin component and the elastomer component may be used at any ratio. However, the resin component and the elastomer component are preferably used at the thermoplastic resin/elastomer component ratio (weight ratio) of 85/15 to 15/85 in order to produce the thermoplastic elastomer composition having the structure wherein the vulcanized elastomer component (domain) is dispersed in the continuous phase (matrix) of the thermoplastic resin. In this case, amount of the elastomer component is limited for the purpose of forming the dispersion structure of the thermoplastic elastomer composition. Accordingly, the amount of the elastomer includes not only the elastomer (main component) as described above but also the vulcanizing agent and other additives generally incorporated in an elastomer.

In addition to the resin component and the elastomer component as described above, the thermoplastic elastomer composition may contain any desired component as long as the merits of the present invention are not impaired. The thermoplastic elastomer composition generally contains various vulcanization agents for the elastomer component.

The vulcanization system is not particularly limited, and may be adequately selected in consideration of the type of the elastomer component and the vulcanization conditions (temperature, time) employed. In the vulcanization system, a sulfur vulcanizing agent or a sulfur vulcanizing accelerator described below can be used by itself or in combination of two or more. The vulcanization system may be the rubber vulcanizing agent (cross linking agent) commonly used in the art. Typical sulfur vulcanizing agents include powdered sulfur, precipitated sulfur, highly dispersible sulfur, surface-treated sulfur, insoluble sulfur, dimorpholine disulfide, and an alkylphenol disulfide which may be used at an amount of, for example, about 0.5 to 4 phr (parts by weight per 100 parts of the elastomer component (polymer)).

Typical organic peroxide vulcanizing agents include benzoyl peroxide, t-butylhydroperoxide, 2,4-dichloro-benzoylperoxide, 2,5-dimethyl-2,5-di(t-butylperoxy)hexane, and 2,5-dimethylhexane-2,5-di(peroxylbenzoate), which may be used at an amount of, for example, about 1 to 15 phr. Typical phenol resin vulcanizing agents are brominated alkylphenol resins, and mixed vulcanizing systems containing a halogen donor such as tin chloride or chloroprene and an alkyl phenol resin. Such phenol resin vulcanizing agent may be used at an amount of, for example, about 1 to 20 phr.

Other agents which may be used include zinc white (about 5 phr), magnesium oxide (about 4 phr), litharge (about 10 to 20 phr), p-quinone dioxime, p-dibenzoyl quinone dioxime, tetrachloro-p-benzoquinone, poly-p-dinitrobenzene (about 2 to 10 phr), and methylene dianiline (about 0.2 to 10 phr).

If necessary, a vulcanization accelerator may also be added to the reaction system. For the vulcanization accelerator, the one commonly used in the art, for example, an aldehyde-ammonia, guanidine, thiazole, sulfenamide, thiuram, dithionate, or thiourea vulcanization accelerator may be used at an amount of, for example, about 0.5 to 2 phr.

Typical aldehyde-ammonia vulcanization accelerators include hexamethylene tetramine;

typical guanidine vulcanization accelerators include diphenylguanidine;

typical thiazole vulcanization accelerators include dibenzothiazyl disulfide (DM), 2-mercaptobenzothiazol and the Zn salt and cyclohexylamine salt thereof;

typical sulfenamide vulcanization accelerators include cyclohexylbenzothiazyl sulfenamide (CBS), N-oxydiethylene benzothiazyl-2-sulfenamide, N-t-butyl-2-benzothiazol sulfenamide, and 2-(Thymorpholinyldithio)benzothiazol;

typical thiuram vulcanization accelerators include tetramethylthiuram disulfide (TMTD), tetraethylthiuram disulfide, tetramethylthiuram monosulfide (TMTM), and dipentamethylene thiuram tetrasulfide;

typical dithionate vulcanization accelerators include n-dimethyldithiocarbamate, Zn-diethyldithiocarbamate, Zn-di-n-butyldithiocarbamate, Zn-ethylphenyldithiocarbamate, Tc-diethyldithiocarbamate, Cu-dimethyldithiocarbamate, Fe-dimethyldithiocarbamate, and pipecolin pipecolyldithiocarbamate; and

typical thiourea vulcanization accelerators include ethylene thiourea and diethylthiourea.

The vulcanization accelerator may be used in combination with a coagent commonly used in the art for the rubber, and exemplary such coagents include zinc white (about 5 phr), stearic acid, oleic acid, and Zn salt thereof (about 2 to 4 phr).

The thermoplastic elastomer composition may also include a lubricant. The lubricant used is not particularly limited, and examples of the preferable lubricants include a surfactant such as organosiloxane, ethylene tetrafluoride powder, molybdenum disulfide, graphite, spheroidal graphite, short fibers, and superfine fibers.

The lubricant incorporated at a content of about 0.05 to 100 parts by weight per 100 parts by weight of the thermoplastic elastomer composition will achieve sufficient lubricating effects, and the composition will also exhibit other properties such as high bending resistance.

When chemical compatibility of the resin component and the elastomer component are different from each other, an appropriate compatibilizer is preferably incorporated as the third component to thereby compatibilize the resin and the elastomer components. Addition of such compatibilizer decreases interfacial tension between the thermoplastic resin composition and the elastomer composition, and as a consequence, particle diameter of the elastomer component constituting the dispersed phase becomes reduced and characters inherent to the resin component and the elastomer component will be effectively realized.

Such compatibilizer may generally comprise the one having the structure of a copolymer having the structure of either one or both of the resin component and the elastomer component; or a copolymer having epoxy group, carboxyl group, carbonyl group, halogen group, amino group, oxazoline group, hydroxyl group, or the like which is capable of reacting with the resin component or the elastomer component. The type of the compatibilizer selected depends on the type of the resin component and the elastomer component which are mixed. Those commonly used, however, include styrene-ethylene-butylene-styrene block copolymer (SEBS) and maleic modification products thereof, EPDM, EPM and maleic modification products thereof, EPDM/styrene or EPDM/acryronitrile graft copolymer and maleic modification products thereof, styrene/maleic acid copolymer, and reactive phenoxin. Although the amount of such compatibilizer incorporated is not particularly limited, the compatibilizer is preferably used at an amount of 0.5 to 20 parts by weight per 100 parts by weight of the polymer component (total of the thermoplastic resin and the elastomer).

In order to improve the flowability, heat resistance, physical strength, cost and the like, the thermoplastic elastomer composition may also include a necessary amount of additives commonly added in such composition, for example, a reinforcing agent, a filler, a softening agent, an antiaging agent, and a processing aid to the extent that does not adversely affect the merits of the present invention. A pigment may also be incorporated in the thermoplastic elastomer composition for coloring purpose.

The pigment used may be an inorganic pigment or an organic pigment.

Exemplary inorganic pigments include oxides such as zinc white, titanium oxide, iron oxide, chromium oxide, iron black, and complex oxides (for example, titanium yellow, zinc-iron brown, titanium-cobalt green, cobalt green, cobalt blue, copper-chromium black, and copper-iron black); chromates such as chrome yellow and molybdate orange; ferrocyanides such as iron blue; sulfides such as cadmium yellow, cadmium red, and zinc sulfide; sulfates such as barium sulfate; silicates such as ultramarine blue; carbonates such as calcium carbonate; phosphates such as manganese violet; hydroxides such as yellow ocher; carbon such as carbon black; metal powders such as aluminum powder and bronze powder; and titanium-coated mica.

Exemplary organic pigments include azo pigments such as monoazo lake pigments (for example, lake red C, permanent red 2B, and brilliants carmine 6B), monoazo pigments (for example, toluidine red, naphthol red, fast yellow G, benzimidazolon bordeaux, and benzimidazolon brown), disazo pigments (for example, disazo yellow AAA, disazo yellow HR, and pyrazolone red), condensed azo pigments (for example, condensed azo yellow, condensed azo red, and condensed azo brown), and metal complex azo pigments (for example, nickel azo yellow); phthalocyanine pigments such as copper phthalocyanine blue, copper phthalocyanine green, and brominated copper phthalocyanine green; dye pigment such as basic dye lake (for example, rhodamine 6 lake); fused polycyclic pigments such as anthraquinone pigments (for example, flavanthrone yellow, dianthraquinolyl red, and indanthrene blue), thioindigo pigments (for example, thioindigo bordeaux), perinone pigments (for example, perinone orange), perylene pigments (for example, perylene scarlet, perylene red, and perylene maroon), quinacridon pigments (for example, quinacridon red, quinacridon magenta, and quinacridon scarlet), dioxadine pigments (for example, dioxadine violet), isoindolinone pigments (for example, isoindolinone yellow), quinophthalone pigments (for example, quinophthalone yellow), isoindoline pigments (for example, isoindoline yellow), pyrrole pigments (for example, pyrrole red); metal complex azomethins such as copper azomethin yellow; aniline black; and daylight fluorescence pigment.

It has been known that chattering of a wiper can be suppressed by reducing the frictional coefficient of the material used for the blade. The frictional coefficient of a thermoplastic resin is generally low, and coefficient of kinetic friction is 0.39 in the case of Nylon 6, 0.23 in high density polyethylene, and 0.56 in polypropyrene. In contrast, coefficient of kinetic friction of an elastomer is high, and vulcanized rubbers have a particularly high coefficient of kinetic friction around about 2 to 3.

Accordingly, advantage associated with the use of a thermoplastic resin having a small frictional coefficient for the wiper may be evident. However, when the thermoplastic resin is used for the wiper blade with no processing, the resulting wiper blade will be too hard to follow the curved surface of the automobile front windshield by far detracting from the wiping performance.

In contrast, when the body of the wiper blade is manufactured from a thermoplastic elastomer composition having the morphology wherein the resin component as described above constitutes the continuous phase (matrix), and the vulcanized elastomer component (domain) is dispersed in such matrix, the surface of the wiper blade that becomes in contact with the glass surface will be constituted substantially from the thermoplastic resin, and the wiper blade will enjoy the reduced frictional coefficient and the chattering will be reduced. In addition, the wiper blade as a whole will exhibit sufficiently improved flexibility owing to the elastomer constituting the dispersed phase, and the wiper blade will be able to fully follow the curved glass.

The thermoplastic elastomer composition having the phase dispersion morphology as described above may not be necessarily obtained by simply melt kneading the resin component and the elastomer component at the weight ratio as described above, and further consideration of the volume ratio and the viscosity ratio is desirable.

It is particularly desirable to select the intrinsic melt viscosity during the kneading of the resin component and the elastomer component. To be more specific, the intrinsic melt viscosity is selected so that the value of α determined by the equation as described below would be smaller than 1. The blend ratio of the components is not limited as long as the value of α does not exceed 1. When α is less than 1, the product will exhibit a sea-island dispersion structure wherein the elastomer component constitute the dispersed phase (island) and the thermoplastic resin constitutes the matrix (sea). When the thermoplastic elastomer composition has such sea-island dispersion structure, the thermoplastic resin constituting the matrix will be flowable in the molding, and the molding as in the case of the thermoplastic resin will be enabled.

α=(Φ_{R}/Φ_{P})×(η_{P}/η_{R})

Φ_{R}: volume fraction of the elastomer component,

Φ_{P}: volume fraction of the resin component,

η_{R}: melt viscosity of the elastomer component under the temperature and shear rate conditions used in the kneading, and

η_{P}: melt viscosity of the resin component under the temperature and shear rate conditions used in the kneading).

When the value of α is 1 or more, the elastomer component will constitute the matrix of the thermoplastic elastomer composition, and the composition will exhibit drastically reduced flowability. When the vulcanizing agent is added to such thermoplastic elastomer composition, the composition will form particles, and molding of the composition will be difficult due to the loss of the flowability.

The melt viscosity η is the melt viscosity at the arbitrary temperature and formulation used in the kneading, and the melt viscosity of the material varies according to the temperature, the shear rate (sec⁻¹), and the shear stress. In general, the melt viscosity can be determined from the stress and the shear rate of the molten polymer material flowing through a capillary tube measured at an arbitrary temperature, in particular, at the temperature range used in the kneading according to the following formula:

η=σ/γ (wherein σ represents the shear stress and γ represents the shear rate).

The melt viscosity may be measured by using a capillary rheometer (Capirograph 1C manufactured by Toyo Seiki).

Dynamic vulcanization of the elastomer component can be accomplished by kneading the elastomer component in the presence of a vulcanizing agent. Therefore, the elastomer component and the vulcanizing agent may be preliminarily kneaded for dynamic vulcanization, and then kneaded with the resin component, or alternatively, the vulcanizing agent may be added during the kneading of the resin component and the unvulcanized elastomer component.

However, the latter method is preferable for the production of the thermoplastic elastomer composition having the structure wherein the dynamically vulcanized elastomer component (domain) is dispersed in the continuous phase (matrix phase) of the resin component, from the resin component and the elastomer component. To be more specific, the unvulcanized elastomer component and the resin component is preferably melt kneaded in a twin-screw compounder or the like, before the dynamic vulcanization of the elastomer component.

The optional additives may be added in the course of kneading. However, it is preferable that the optional additives other than the vulcanizing agent is preliminarily incorporated in the resin component or in the elastomer component before the kneading.

The kneading of the resin component and the elastomer component may be accomplished by using a kneading machine commonly used in the art, for example, a screw extruder, a kneader, a Banbury mixer, or a twin-screw compounder. Among these, use of a twin-screw compounder is preferable when the elastomer component is dynamically vulcanized in the kneading of the resin component and the elastomer component.

The kneading of the resin and the elastomer components may be accomplished also by sequentially using two or more kneading machines of different type.

The melt kneading is preferably accomplished at a temperature equal to or higher than the melting temperature of the thermoplastic resin. The shear rate in the kneading is preferably in the range of 500 to 7500 sec⁻¹. The total period of the kneading is typically about 30 seconds to 10 minutes, and the vulcanization period after the addition of the vulcanizing agent is typically about 15 seconds to 5 minutes.

The elastomer component in the thus produced thermoplastic elastomer composition has been dynamically crosslinked. To be more specific, the crosslinking of the elastomer has proceeded during the kneading of the thermoplastic resin and the elastomer component. As a consequence, the thermoplastic elastomer composition used in the present invention is obtained in the form wherein the phase of the crosslinked elastomer has been finely dispersed in the continuous phase of the thermoplastic resin.

In the present invention, the base (thermoplastic elastomer composition) may preferably have a hardness (JIS-A) of 50 to 80. When the base has a hardness (JIS-A) of 50 or more, the wiper blade will not be excessively curled to the extent that no turning is enabled. When the base has a hardness (JIS-A) of 80 or less, the wiper blade will fully contact the glass surface to realize outstanding wiping performance.

As described above, when a wiper blade is formed from the thermoplastic elastomer composition wherein the continuous phase comprises the resin component by integrally molding with the reinforcement, it will be the resin component of the thermoplastic elastomer composition (base 1) that becomes in contact with the glass. The resin component has low frictional coefficient as well as high wear resistance, and therefore, the chattering noise of the wiper blade will be suppressed and durability will be improved.

<Reinforcement>

The wiper blade of the present invention is produced by using the thermoplastic elastomer composition as described above for the base 1, and integrally molding the base 1 with the reinforcement 2. The reinforcement imparts the wiper blade with rigidity, and the reinforcement is not particularly limited for its size, shape, number, location, material, and the like as long as the wiper blade produced by integral molding has the rigidity equivalent to that of the wiper blade produced by conventional assembly process.

The reinforcement 2 may be produced by using, for example, a metal, glass fiber, carbon fiber, a resin, an FRP (fiber reinforced plastic), and a composite material thereof.

The metal used may be, for example, iron, aluminum, copper, stainless steel, or an alloy of two or more such metals, although the metal used is not limited to such metals. Among such metals, the preferred is stainless steel in view of the rigidity and the corrosion resistance.

The reinforcement may be also produced from a thermoplastic resin which has been mentioned above as the resin component in the thermoplastic elastomer composition or a thermosetting resin. Use of a thermoplastic resin is particularly preferable in view of the strong adhesion realized between the reinforcement and the base which leads to the improvement in the durability of the wiper blade. The thermoplastic resin may also have a glass fiber or a carbon fiber incorporated therein for the purpose of improving the rigidity of the reinforcement.

Exemplary thermosetting resins include phenol resin, urea resin, melamine resin, epoxy resin, and silicone resin.

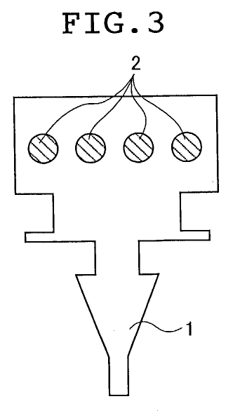

Various embodiments of the wiper blades having the reinforcements as described above incorporated therein are shown in the drawings. The wiper blade of FIG. 1 is an embodiment wherein the reinforcement 2 in the form of a plate having a rectangular cross section is incorporated in the base 1 that has been formed in the shape of the body. FIGS. 2 to 4 are (transverse) cross sectional views showing other embodiments of the wiper blades according to the present invention. To be more specific, FIG. 2 shows an embodiment wherein two pieces of the reinforcements 2 each having a rectangular cross section have been incorporated in the base 1. FIG. 3 shows an embodiment wherein four pieces of columnar reinforcements 2 have been incorporated in the base 1.

The wiper blades shown in FIGS. 1 to 3 are the those wherein the reinforcement has been embedded in the interior of the blade without being exposed to the surface of the wiper blade. The reinforcement, however, may be partly or entirely exposed to the surface of the blade. In addition, the wiper blade may be the one wherein the reinforcement does not fully extend to opposite side surfaces of the wiper blade as in the case of the one shown in FIG. 1, or the one wherein the reinforcement extends along full width of the wiper blade to the opposite side surfaces of the wiper blade.

The reinforcement is not necessarily arranged at an intermediate position in the cross section of the wiper blade, and the reinforcement may also be placed on the upper side or the lower side.

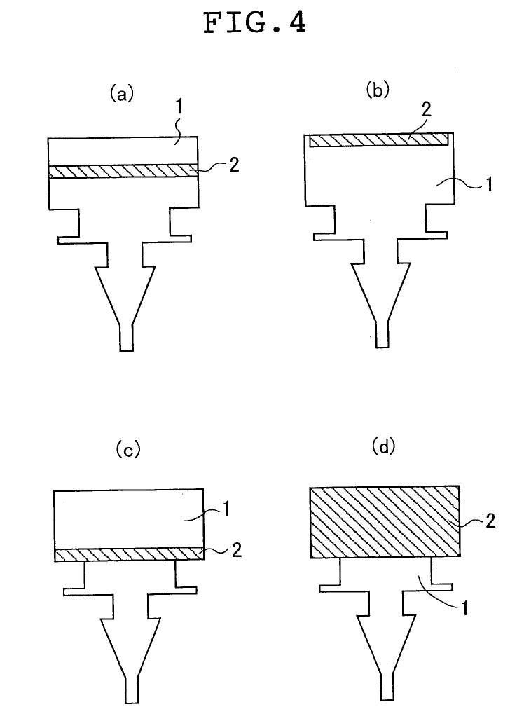

In FIG. 4(a), for example, the reinforcement 2 extends to the opposite side surfaces of the wiper blade with opposite end surfaces of the reinforcement 2 being exposed. FIG. 4(b) is an embodiment wherein the upper surface of the reinforcement 2 is exposed, and FIG. 4(c) is an embodiment wherein the lower surface of the reinforcement 2 is exposed. FIG. 4(d) is an embodiment wherein the upper, the lower and the end surfaces of the reinforcement 2 are exposed.

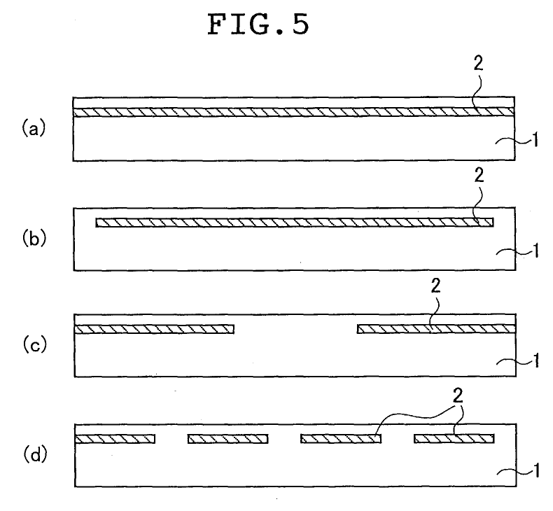

The reinforcement may extend in longitudinal direction along the full length of the wiper blade, or alternatively, the reinforcement may not extend to the opposite longitudinal ends of the wiper blade. In addition, the cross section of the reinforcement may be uniform along the full length of the wiper blade, or different depending on the position along the length of the wiper blade. FIG. 5 shows the wiper blades of the present invention in longitudinal cross sectional views taken in the direction perpendicular to the direction of FIG. 1. FIG. 5(a), for example, shows the embodiment wherein the reinforcement is provided continuously along the length of the wiper blade, and FIG. 5(b) shows the embodiment wherein the reinforcement is not provided at opposite longitudinal ends of the wiper blade. Shown in FIGS. 5(c) and (d) are the embodiments employing discontinuous reinforcement, wherein the reinforcement is not provided at one or more positions along the length of the wiper blade.

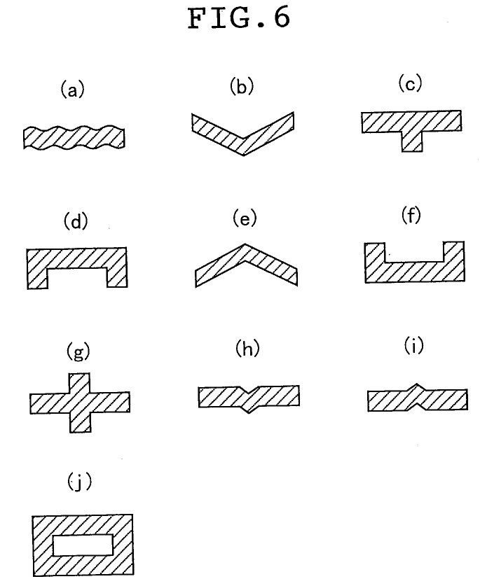

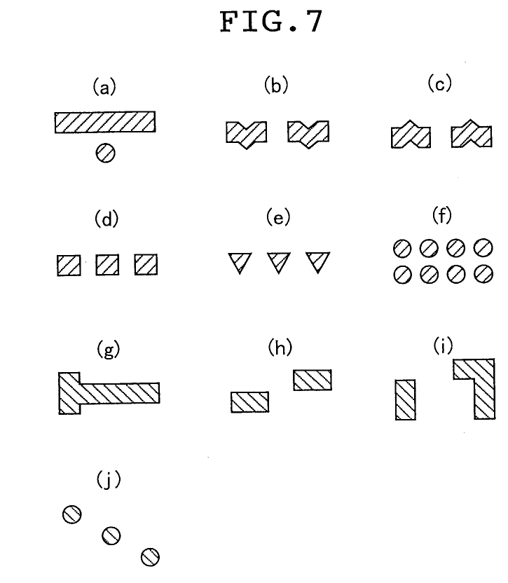

FIG. 6 shows further embodiments of the reinforcement 2 in transverse cross sectional views. FIG. 6 only shows the reinforcements, and the reference numeral “2” is omitted. FIGS. 6(a) to (i) are transverse cross sections of various embodiments of the reinforcement 2 corresponding to the wiper blade of FIG. 1 provided with a continuous reinforcement having one uniform cross section. FIG. 7 shows further embodiments of the reinforcement. When seen in transverse cross sectional view, the reinforcement may comprise a plurality of axisymmetrically arranged reinforcements as shown in FIGS. 7(a) to (f), or alternatively, a plurality of asymmetrically arranged reinforcements as shown in FIGS. 7(g) to (j).

The examples have been given in order to illustrate various embodiments of the reinforcement, and it is to be noted that the wiper blade of the present invention is not limited to the embodiments shown in the drawings as long as the integral molding of the reinforcement and the thermoplastic elastomer composition has been enabled.

<Molding Method>

In the present invention, the method used in the molding is not particularly limited as long as the thermoplastic elastomer composition and the reinforcement can be integrally molded. However, the wiper blade is preferably produced by co-extruding the reinforcement and the thermoplastic elastomer composition. In order to produce the wiper blade in most efficient manner, the wiper blade of the same profile may be molded in an infinite length, and the required length may be cut out from the continuously molded blade for use as the wiper blade.

For example, when the reinforcement comprises a metal, the molding may be accomplished by preliminarily winding the metal in a roll and inserting the metal reinforcement through the die, and covering the reinforcement with the thermoplastic elastomer composition. When the reinforcement comprises a resin, two extruders may be used for integral molding of the thermoplastic elastomer composition and the reinforcement by co-extrusion, or alternatively, a tandem system may be employed wherein the reinforcement is formed from the resin while the thus formed reinforcement is covered with the thermoplastic elastomer composition.

It is to be noted that, in the present invention, the wiper blade may also be produced from thermoplastic elastomer and the reinforcement as described above by injection molding, namely, by preliminarily inserting the reinforcement in the mold, and injection molding the thermoplastic elastomer composition to thereby produce the wiper blade.

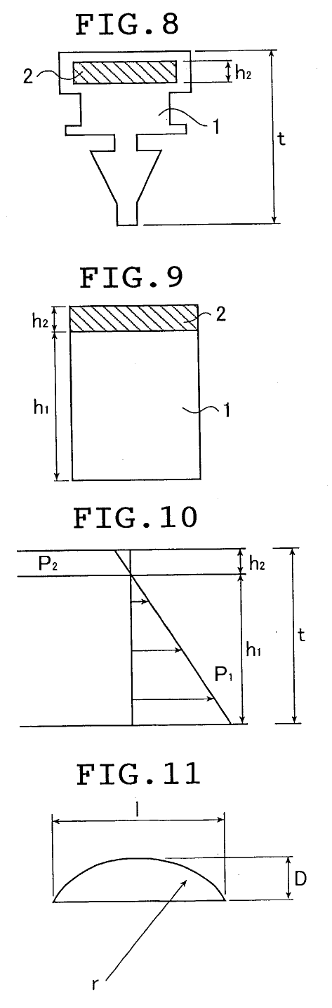

The wiper blade according to the second aspect of the present invention is shown in FIG. 8 (corresponding to FIG. 1) in schematic cross sectional view. FIGS. 9 to 11 are presented for the purpose of explaining this aspect of the invention.

The wiper blade according to the second aspect of the present invention is an integrally molded product of the base 1 comprising the thermoplastic elastomer composition and the reinforcement 2, which meets the features (1) and (2) as described below.

(1) When the thermoplastic elastomer composition and the reinforcement have a Young's modulus of E₁ and E₂, respectively; difference in the shrinkage of the materials is δᵣ; and said wiper blade is regarded as a bilayer structure (FIG. 9) substantially comprising the layer of the base 1 and the layer of the reinforcement 2; the curving coefficient K determined by the following equation (i) is 1×10⁻³ or less.

K=2δᵣ/[3+{(1+mn)(1+mn³)/mn(1+n)²}] (i)

In the equation, δᵣ represents the difference in the shrinkage between the base and the reinforcement;

m=E₁/E₂ (wherein E₁ is the Young's modulus of the base, and E₂ is the Young's modulus of the reinforcement); and

n=h₁/h₂ (wherein h₁ is the thickness [mm] of the base, and h₂ is the thickness [mm] of the reinforcement).

It is to be noted that the height of the thermoplastic elastomer composition indicated in FIG. 9 as h₁ is equivalent to (t−h₂) in FIG. 8.

The curving coefficient K calculated by using the equation (i) may serve an index for the deflection of the wiper blade in longitudinal direction as described below in further detail.

In a composite material as schematically shown in FIG. 9 comprising a base (thermoplastic elastomer composition) 1 and a reinforcement 2, the shrinkage of the base 1 and the reinforcement 2 is generally different from each other, and it is commonplace that the base 1 shows a relatively high shrinkage and the reinforcement 2 shows a relatively low shrinkage. With regard to such composite material comprising the materials of higher and lower shrinkages, the estimation of the deflection may be accomplished by utilizing the curving coefficient K which has been proposed for a bimetal (“Bimetal and Thermostat” by Fujimoto, Fuji Kinzoku, Co., Ltd. disclosed on the internet), as described below.

This estimation is explained hereinbelow by referring to FIGS. 10 and 11.

In the molding, stress P₁ and stress P₂ are induced by the shrinkage at the molding.

P₁=P₂=P (1)

The material with higher shrinkage and the material with lower shrinkage will receive bending moments M₁ and M₂, respectively.

M₁=(h₁/2)P₁ (2),

and

M₂=(h₂/2)P₂ (3).

The total thickness t is (h₁+h₂)

M₁+M₂=(P₁h₁/2)+(P₂h₂/2)=P(h₁+h₂)/2=Pt/2 (4).

If the wiper blade having a longitudinal length l as shown in FIG. 11 curves at the radius of curvature of r after the shrinkage, and the moment of inertia is I, l/r=M/EI, and therefore, M=EI/r, and accordingly,

M₁=E₁I₁/r, (5),

and

M₂=E₂I₂/r, (6).

The equation (4) is then represented by equation (7).

M₁+M₂=Pt/2=(E₁I₁+E₂I₂)/r (7)

In the meanwhile, unit elongation is equal at the interface, and therefore,

ρ₁+P₁/E₁+h₁/2r=ρ₂−P₂/E₂h₂−h₂/2r (8)

From the equation (8),

l/r=(ρ₂−ρ₁)/(t/2+2(E₁I₁+E₂I₂)(1/E₁h₁+1/E₂h₂)/t) (9)

When the moment of inertia I in the equation (9) is the unit width, and I₁=h₁³/l₁ and I₂=h₂³/l₂,

l/r=6(ρ₂−ρ₁)(h₁+h₂)h₁h₂E₁E₂/3(h₁+h₂)²h₁h₂E₁E₂+(h₁E₁+h₂E₂)(h₁³E₁+h₂³E₂)] (10)

When the ratio of the Young's modulus m=E₁/E₂, and the ratio of the plate thickness n=h₁/h₂ in equation (10),

l/r=6(ρ₂−ρ₁)(1+n²)/t[3(1+n²)+(1+mn)(n²+1/mn)] (11)

When K is such that

3(ρ₂−ρ₁)(1+n²)/[3(1+n²)+(1+mn)(n²+1/mn)]=K,

K=3Δρ/[3+(1+mn)(1+n³m)/ₘₙ(1+n)²] (12)

The equation (11) will be represented as

l/r=2K/t (13)

When the deflection in FIG. 11 is designated D,

D=l²/8r (14)

When the equation (14) is introduced in the equation (13),

D=Kl²/4t (15)

As evident from the equation (15), the curving coefficient K can be used as an index for the deflection D.

The equation (i) has been explained with regard to the blade having the rectangular cross section as shown in FIG. 8 for the convenience of the explanation. This explanation, however, also applies to other embodiments as long as the cross section of the reinforcement can be approximated to the rectangular shape schematically shown in FIG. 9.

(2) The wiper blade of the present invention exhibits a distortion of 20 to 80 mm, and preferably 30 to 60 mm when a concentrated load of 50 g is placed at one end of the wiper blade having a length of 200 mm.

In the present invention, the thermoplastic elastomer composition of the base and the reinforcement are not particularly limited as long as they are integrally moldable, and the features as described above are satisfied. However, in view of the desirable features of the wiper blade, the base is preferably formed from a thermoplastic elastomer composition comprising a thermoplastic resin (resin component) and a dynamically crosslinked elastomer component wherein said dynamically crosslinked elastomer component is dispersed in the continuous phase of the resin component. Such thermoplastic elastomer composition has been described in detail for the first aspect of the invention, and the explanation is not repeated here. The preferable resin component and its melting point, the elastomer component, the optional components, and the hardness are also substantially equivalent to those described for the first aspect of the invention, and the thermoplastic elastomer composition may be selected from those described above so that the thermoplastic elastomer composition meets the conditions (1) and (2) as described above.

The reinforcement is the component that imparts the wiper blade with the rigidity, and the requirement is that the wiper blade produced by the integral molding meets the rigidity (1) and curving coefficient (2) desired for the wiper blade. Accordingly, the reinforcement used in this invention is not particularly limited for its size, shape, number, location, material, and the like as long as it can be approximated to the configuration shown in FIG. 9, and the desired curving coefficient is achieved. For example, the cross section of the reinforcement may be rectangular as in the case of a foil, a plate, or a box, oblong, or corrugated, and the blade may be the one including two or more reinforcements. The embodiments of the reinforcement other than the one shown in FIG. 8 include those shown, for example, in FIGS. 6(a) to (i) and FIGS. 7(b) to (d) and (g) in their vertical cross sectional views. The wiper blade may also have two or more reinforcements incorporated therein. The reinforcement may extend in longitudinal direction along the full length of the wiper blade, or alternatively, the reinforcement may not extend to the opposite longitudinal ends of the wiper blade. In addition, the cross section of the reinforcement may be uniform along the full length of the wiper blade, or may vary depending on the position along the length of the wiper blade.

In addition, the reinforcement is not limited to the one incorporated in the interior of the wiper blade, and the reinforcement may be partly exposed to the exterior of the wiper blade as shown in FIG. 4.

The integral molding of the base (thermoplastic elastomer composition) and the reinforcement may be conducted as in the case of the first aspect of the present invention.

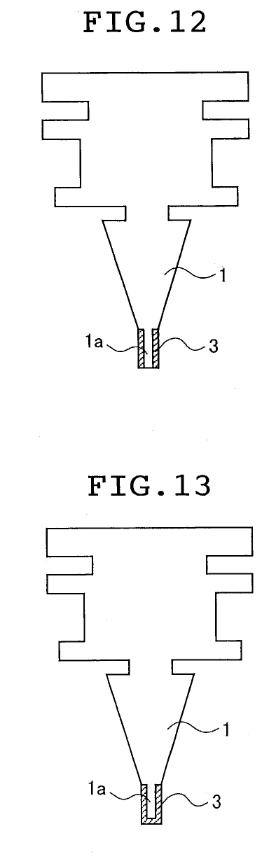

The wiper blades according to the third aspect of the present invention are shown in FIGS. 12 to 14 in cross sectional views.

As shown in FIG. 12, the wiper blade comprises a body (base 1) and a surface coating layer 3 which covers at least the surface of the edge portion of said body.

The body comprises the base 1, which comprises a thermoplastic elastomer composition. This thermoplastic elastomer composition comprises at least a thermoplastic resin and a dynamically crosslinked elastomer component, and the thermoplastic elastomer composition has a structure wherein the dynamically crosslinked elastomer component is dispersed in a continuous phase of the thermoplastic resin.

Such thermoplastic elastomer composition has been described in detail for the first aspect of the invention, and the explanation is not repeated here. The preferable resin component and its melting point, the elastomer component, the optional components, and the hardness are also substantially equivalent to those described for the first aspect of the invention.

Since the body base 1 is made of a thermoplastic elastomer composition comprising the continuous phase of a thermoplastic resin and the dispersed phase of an elastomer component, the wiper blade can be produced in an efficient manner by extrusion or other method commonly used in the molding of a plastic. In addition, due to the crosslinking of the elastomer composition constituting the dispersed phase, the wiper blade exhibits an excellent setting property, and enjoys the merit of not undergoing degradation even when left under the harsh conditions of the scorching sun in midsummer.

The material used for the surface coating layer 3 in the wiper blade of the present invention is not limited to any particular type, and various thermoplastic resins and thermoplastic elastomer compositions may be used for the surface coating layer 3. Typical examples include the thermoplastic elastomer composition used for the base and the thermoplastic resin described as the resin component used for the continuous phase of the thermoplastic elastomer composition. In either case, the surface of the surface coating layer 3 that becomes in contact with the glass will be constituted from the resin component phase which has a smaller frictional coefficient and superior abrasion resistance compared to the elastomer, and as a consequence, the wiper blade will exhibit reduced chattering noise and improved durability.

When the surface coating layer 3 is produced from a thermoplastic elastomer composition, the thermoplastic elastomer composition used may be either different from the one used for the body base 1 or the same with the one used for the body base 1 (for example, the one wherein the type of the resin and the elastomer components used are the same as the one used for the body base 1 but different in the blend ratio). However, the resin components of the thermoplastic elastomer compositions used for the base 1 and the surface coating layer 3 are preferably the same since, if the resin component constituting the continuous phase is common, a higher adhesion will be achieved between the body base 1 and the surface coating layer 3, and the wiper blade will enjoy an improved durability. Integral molding by co-extrusion will also be facilitated in the production of the wiper blade.

In view of the adhesion, it is preferable that the thermoplastic elastomer composition used for the base 1 and the surface coating layer 3 comprises the same resin and elastomer components, which are used at a different blend ratio.

The hardness (JIS-A) of surface coating layer 3 is preferably higher than that of the body base 1. The body base 1 may preferably have a hardness (JIS-A) of 50 to 80. When the base has such hardness, the flexibility will be adequate and the wiper blade will exhibit excellent wiping performance. In particular, when the hardness (JIS-A) is 50 or more, the wiper blade will not be excessively curled to the extent that no turning is enabled. When the hardness (JIS-A) is 80 or less, the wiper blade will fully contact the glass surface to realize outstanding wiping performance.

The surface coating layer 3 may preferably have a hardness (JIS-A) of 70 to 99. When the hardness is within such range, the chattering noise will be most efficiently suppressed and the abrasion resistance will be improved.

The method used for adjusting the hardness of the body base 1 and the surface coating layer to the ranges as described above is not particularly limited, and the adjustment may be accomplished, for example, by controlling the type and content of the crosslinking agent or other additives. When the body base 1 and the surface coating layer 3 are produced from the thermoplastic elastomer compositions comprising the resin component and the elastomer component of the same type, the hardness can be adjusted to the ranges as described above by simply using the components at different blend ratio. Alternatively, the desired hardness may be attained by incorporating a filler such as silica in the surface coating layer 3.

The surface coating layer 3 may preferably have a melting point of 200° C. or higher. In the use of a wiper blade, there are occasions when the wiping is continued without stopping the wiper blade motion with no moisture on the glass surface, for example, in the case of snow or in the tunnel. Even if such wiping of the dry glass surface is continued for a prolonged period, the blade is prevented from melting by the frictional heat if the surface coating layer has a melting point of 200° C. or higher.

The surface coating layer 3 may also include a lubricant.

The lubricant used is not particularly limited, and examples of the preferable lubricants include a surfactant such as organosiloxane, ethylene tetrafluoride powder, molybdenum disulfide, graphite, spheroidal graphite, short fibers, and superfine fibers.

The lubricant is preferably incorporated at a content of about 0.05 to 100 parts by weight per 100 parts by weight of the thermoplastic resin polymer component. When added at such content, the lubricant will achieve sufficient lubricating effects, and the wiper blade will also exhibit high bending resistance and the like.

In one preferable embodiment, the body (base 1) and the surface coating layer 3 are different in color. When the wiper blade is used for a prolonged period, the surface coating layer 3 becomes abraded. When the body 1 and the surface coating layer 3 are different in their color, the user can easily know the timing to change the wire blade since the user can visually recognize the exposure of the body 1.

The method used to differentiate the colors of the body 1 and the surface coating layer 3 is not particularly limited, and either one or both of the body 1 and the surface coating layer 3, for example, may be colored with a pigment.

The surface coating layer 3 is not particularly limited for its thickness. However, the surface coating layer 3 preferably has a thickness of 1 to 200 μm, and more preferably, 20 to 100 μm. When the thickness is within such range, the wiper blade will exhibit improved durability as well as sufficient initial wiping performance.

FIGS. 12 to 14 show the wire blade embodiments wherein a surface coating layer 3 is provided on the edge 1a.

In FIG. 12, two surface coating layers 3 and 3 are provided on opposite surfaces of the edge la of the body (base) 1, respectively. In the case of the embodiment shown in FIG. 12, the surface coating layer 3 covers the entire area of the opposite surfaces of the edge 1a. The surface coating layer 3, however, is only required to cover at least a part of the surface of the edge 1a of the body (base 1), and in the case when a limited part of the edge la becomes in contact with the glass surface in the use, the surface coating layer 3 may be provided only in the area that becomes in contact with the glass surface.

The surface coating layer 1 may also cover all or a part of the surface of the body 1 other than the surface of the edge 1a.

FIG. 13 is a cross sectional view showing another embodiment wherein all of the surfaces on opposite sides and at the distal end of the edge la of the body 1 are covered by one surface coating layer 3. In FIG. 13, the body 1 and the surface coating layer 3 may be prepared from materials of different colors. As mentioned above, the color of the body will emerge when the surface coating layer is abraded after a prolonged use, and this color change serves an indicator mark to change the wire blade.

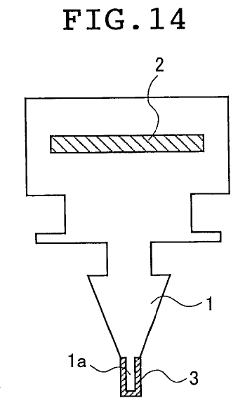

FIG. 14 is a cross sectional view showing another embodiment wherein, in the embodiment of FIG. 12, the body comprises the base 1 and the reinforcement 2 incorporated in the base 1. It is to be noted that the present invention is not limited to the embodiments shown in the attached drawings.

The method for producing such wiper blade of the present invention is not particularly limited.

For example, the base material 1 constituting the body and the surface coating layer material 3 may be integrally molded by co-extrusion; or injection molded by the so called coinjection molding. Alternatively, the body and the surface coating layer may be separately produced from each other, and then bonded with an adhesive; or the body and the surface coating layer may be preliminarily molded so that these components can fit with each other, and then fitting one to the other.

Among such methods, integral molding of the body with the surface coating layer by co-extrusion is preferable as in the case of first and second aspects of the present invention. The integral molding by co-extrusion is advantageous since the number with the reinforcement is preferable since the number of production operations can be reduced.

The wiper blade of the present invention may also be integrally molded with a wiper reinforcement comprising a metal or a resin. Such integral molding with the reinforcement is advantageous since the number of production operations can be further reduced.

The wiper blade according to the fourth aspect of the present invention is constituted at least from a body comprising a thermoplastic elastomer composition, and an edge comprising a thermoplastic elastomer composition or a thermoplastic resin composition. If desired, some parts of the body may comprise a material different from the thermoplastic elastomer composition depending on the function required for the respective parts. The body and the edge may also comprise one integrally molded part.

In the wiper blade of the present invention constituted as described above, at least the part of the edge that becomes in contact with the glass has a ten point average roughness of 2 to 50 μm, and preferably, 5 to 30 μm.

The ten point average roughness used in the present invention is the ten point average roughness (R_{z}) defined in JIS B0601-1994. This ten point average roughness (R_{z}) is the difference between the average elevation of the five highest peaks and the average elevation of the five deepest valleys expressed in the unit of μm. The elevation is measured in the direction of the depth by using the roughness profile. It is to be noted that, in the present invention, the cut off value is 2.5 mm, and the sampling length is 8 mm.

When the ten point average roughness (R_{z}) exceeds 50 μm, streaks may remain on the glass surface due to the surface irregularity of the wiper blade resulting in the insufficient wiping performance of the wiper blade. On the other hand, when the ten point average roughness (R_{z}) is less than 2 μm, the contact area of the wiper blade with the glass surface, and in turn, frictional resistance between the glass surface and the wiper blade will be increased with the chattering of the wiper blade remaining occasionally unsuppressed.

The means employed for regulating the ten point average roughness (R_{z}) of the surface that becomes in contact with the glass to the range of 2 to 50 μm, that is, the means used to provide a surface irregularity with the surface that becomes in contact with the glass is not particularly limited. Exemplary methods include, incorporation of a filler at least in the part of the edge that becomes in contact with the glass, surface roughening of the surface of the edge that becomes in contact with the glass by such means as sand blasting, and injection molding in a mold having the surface roughening pattern.

Among such methods, the preferred is the inclusion of a specific filler at least in the material used for the part of the edge that becomes in contact with the glass. Such inclusion is typically accomplished, for example, by mixing a particular amount of the specific filler during the kneading of the thermoplastic resin composition or the thermoplastic elastomer composition used for the edge, and subsequently extruding the thus prepared composition; or by molding the edge and subsequently coating at least the surface of the edge that becomes in contact with the glass with a coating composition containing the specific filler.

The specific filler employed is preferably a lubricating filler which is capable of imparting the lubricity and which has an average particle size of up to 40 μm.

The lubricating filler is not particularly limited as long as the conditions as described above are satisfied. Exemplary lubricating fillers include graphite, molybdenum disulfide, polyethylene tetrafluoride (PTFE), and glass beads having an average particle size of up to 40 μm. Among these, the preferred are graphite, molybdenum disulfide, and PTFE. In the case of these fillers, atoms are bonded differently depending on the direction, and the crystal structure becomes collapsed when the force of certain direction is applied to the crystal structure. The lubricity is thereby imparted. When such filler is dispersed in a polymer and used as the edge material, crystal structure will become partly collapsed upon contact of the edge with the glass surface to enable wiping of the glass surface with small resistance.

Use of a filler having an average particle size in excess of 40 μm is not preferable, since the ten point average roughness (R_{z}) of the part of the edge that becomes in contact with the glass surface may exceed 50 μm to detract form the wiping performance.

When at least the part of the edge that becomes in contact with the glass surface is provided with the surface irregularity by means of incorporating a lubricating filler in the edge material as described above, it is preferable that at least the material of the edge constituting the part that becomes in contact with the glass contains 3 to 50 vol %, and more preferably 10 to 25 vol % of a filler having an average particle size 40 μm.

When the content of the lubricating filler is less than 3 vol %, the ten point average roughness (R_{z}) of the surface of the edge that contacts the glass may become less than 2 μm, and the surface in contact with the glass may suffer from insufficient frictional coefficient with the chattering of the wiper blade unsuppressed.

On the contrary, when the content of the lubricating filler is in excess of 50 vol %, it may become difficult to incorporate the lubricating filler of such an excessive amount in the thermoplastic elastomer composition or the thermoplastic resin composition, and smooth extrusion may become difficult.

The thermoplastic elastomer composition used to constitute the body is not particularly limited. The thermoplastic elastomer composition, however, is preferably a thermoplastic elastomer composition wherein a dynamically crosslinked elastomer component is dispersed in a thermoplastic resin matrix. Such thermoplastic elastomer composition has been described in detail for the first aspect of the invention, and the explanation is not repeated here. The preferable resin component and its melting point, the elastomer component, the optional components, and the hardness are also substantially equivalent to those described for the first aspect of the invention.

Since the body base 1 is made of a thermoplastic elastomer composition comprising the continuous phase of a thermoplastic resin and the dispersed phase of an elastomer component, the wiper blade can be produced in an efficient manner by extrusion or other method commonly used in the molding of a plastic. In addition, due to the crosslinking of the elastomer composition constituting the dispersed phase, the wiper blade exhibits an excellent setting property, and enjoys the merit of not undergoing degradation even when left under the harsh conditions of the scorching sun in midsummer.

The material used for the edge in the wiper blade of the present invention is not limited to any particular type, and various thermoplastic resins and thermoplastic elastomer compositions may be used for the edge.

Exemplary thermoplastic resins are the thermoplastic resins which have been described in the foregoing as the resin component used to form the matrix of the thermoplastic elastomer composition. Exemplary thermoplastic elastomers which may be used are similar to those included in the thermoplastic elastomer composition used for the body base.

When the edge is produced from a thermoplastic elastomer composition, the thermoplastic elastomer composition used may be either different from the one used for the body base or the same with the one used for the body base (for example, the one wherein the type of the resin and the elastomer components used are the same as the one used for the body but different in the blend ratio). However, the resin components of the thermoplastic elastomer compositions used for the body base and the edge are preferably the same since, if the resin component constituting the continuous phase is common, a higher adhesion will be achieved between the body base and the edge, and the wiper blade will enjoy an improved durability. Integral molding by co-extrusion will also be facilitated in the production of the wiper blade.

In view of the same situation, it is preferable that the thermoplastic elastomer composition used for the body base and the edge comprises the same resin and elastomer components, which may be used at a different blend ratio. In such a case, the body and the edge may comprise the same thermoplastic elastomer composition, and the lubricating filler may be incorporated only in the edge portion.

The edge may preferably have a melting point of 200° C. or higher. In the use of a wiper blade, there are occasions when the wiping is continued without stopping the wiper blade motion with no moisture on the glass surface, for example, in the case of snow or in the tunnel. Even if such wiping of the dry glass surface is continued for a prolonged period, the blade is prevented from melting by the frictional heat if the edge has a melting point of 200° C. or higher.

The edge is not particularly limited for its thickness. However, the edge preferably has a thickness of 1 to 800 μm, and more preferably, 20 to 600 μm. When the thickness is within such range, the wiper blade will exhibit improved durability as well as sufficient initial wiping performance.

With regard to the configuration of the edge, the entire edge may be fabricated from a thermoplastic material preferably containing a lubricating filler, or alternatively, the material constituting the body may be sandwiched between the edge material.

In the wiper blade of the present invention having such an edge, the body may preferably have a hardness (JIS-A) of 50 to 80. When the body has such hardness, the flexibility will be adequate and the wiper blade will exhibit excellent wiping performance. When the body has a hardness (JIS-A) of 50 or more, the wiper blade will not be excessively curled to the extent that no turning is enabled. When the body has a hardness (JIS-A) of 80 or less, the wiper blade will fully contact the glass surface to realize outstanding wiping performance.

The hardness (JIS-A) of the edge is preferably such that the ratio of the hardness (JIS-A) of the edge to the hardness (JIS-A) of the body ((JIS-A hardness of the edge)/(JIS-A hardness of the body)) is in the range of 0.6 to 2.0, and more preferably, 1.0 to 1.8. When the hardness is within such range, the wiper blade will exhibit improved wiping performance as well as excellent abrasion resistance. When the hardness ratio is less than 0.6, an excessively acute angle will be formed between the edge and the glass surface, and the contact area may increase to detract from the sliding properties. When the hardness ratio is in excess of 2.0, the edge will be too hard, and the edge may fail to follow the curvature of the glass surface.

The method used for adjusting the hardness of the body and the edge to the ranges as described above is not particularly limited, and the adjustment may be accomplished, for example, by controlling the type and content of the crosslinking agent or other additives. When the body and the edge are produced from the thermoplastic elastomer compositions comprising the resin component and the elastomer component of the same type, the hardness of the wiper blade can be adjusted to the ranges as described above by simply using the components at different blend ratio.

The production method used in the production of the wiper blade of the present invention is not particularly limited. The wiper blade, however, is preferably produced in a continuous manner by integrally molding the body and the edge by co-extrusion, and thereafter cutting the molded wiper blade at the determined length. The co-extrusion method is not particularly limited, and in a typical process, the composition for the body and the composition for the edge are simultaneously supplied to one common dye for the production of a bilayered extruded article. Compared to the production by press molding, integral molding of the wiper blade by co-extrusion has a merit that the number of production operations can be reduced.

### EXAMPLES

Next, the present invention is described in further detail by referring to Examples, which by no means limit the scope of the present invention.

<Preparation of Thermoplastic Elastomer Composition>

The thermoplastic elastomer compositions used in the Examples were prepared as described below.

The components were introduced in Banbury mixer at the blend ratio (weight ratio) as shown in Table 1. After kneading for about 3 minutes, the mixture was taken out at 120° C., and pelletized in a rubber pelletizer.

TABLE 1

| Elastomer compound (parts by weight) | 1 | 2 |
|---|---|---|
| Elastomer: | | |
| Acrylic rubber (ACM): Nipol AR71 | 100 | |
| manufactured by Zeon Corp | | |
| Ethylene-propylene-diene rubber (EPDM): | | 100 |
| Esprene 600F manufactured by Sumitomo | | |
| Chemical Co., Ltd. | | |
| Carbon (GPF): | | |
| Seast V manufactured by Tokai | 40 | 50 |
| Carbon Co., Ltd.) | | |
| Plasticizing agent: | | |
| Dioctyl phthalate (DOP): manufactured by | 10 | |
| Mitsubishi Chemical Corp. | | |
| Paraffin oil: Machine oil 22 manufactured | | 50 |
| by Showa Shell Sekiyu K.K.) | | |
| Antiaging agent: | | |
| Irganox 1010 manufactured by Ciba-Geigy | 2 | 1.5 |
| Japan | | |
| Processing aid: | | |
| Armeen D18 manufactured by Lion-Akzo | 2 | 1 |

The pellets of the elastomer compound that had been produced as described above and the components shown in Table 2 were dry-blended, and introduced in a twin screw kneader wherein the front part was set at 180° C. and the rear part was set at 220° C. The mixture was kneaded at a shear rate of 1000 sec⁻¹, and when fully kneaded, vulcanization system was introduced to obtain the thermoplastic elastomer composition. Melt viscosity of each composition was measured under the conditions used in the kneading (measured resin temperature, 220° C.; shear rate, 1000 sec⁻¹) with a capillary rheometer, and the α value as described above was calculated. These values are also shown in Table 2. Of the compositions produced, proportion of the elastomer component blended was too large (α≧1) in the case of the thermoplastic elastomers 3 and 4, and the mixture could not be kneaded due to reversal of the sea-island structure, and no sample could be obtained.

The resulting thermoplastic elastomer compositions were observed under a transmission electron microscope, and it was confirmed that the thermoplastic elastomer composition 1 and 2 had a structure wherein the elastomer component was dispersed in the continuous phase of the resin component.

In Table 2,

COPE: polyester thermoplastic elastomer (Pelprene P95C manufactured by Toyobo Co., Ltd.; hardness (JIS-A), 95; melting point, 213° C.)

PP: polypropyrene (RB121D manufactured by Tokuyama; melting point, 150° C.)

Vulcanization System:

(1) Zinc white: zinc white No. 3 manufactured by Seido Chemical.

(2) Stearic acid: bead stearic acid manufactured by NOF Corp.

(3) Butane tetracarboxylic acid: BTC manufactured by Mitsui Toatsu Fine Chemicals Inc.

(4) Brominated phenol resin: Tackrol 250-I manufactured by Taoka Chemical Co., Ltd.

The resulting thermoplastic elastomer composition was molded in the form of a plate having a thickness of 2 mm, and 3 plates were placed one on another to measured the hardness (JIS-A) (according to JIS K6253) The hardness is shown in Table 2.

TABLE 2

| | Thermoplastic elastomer | | | |
|---|---|---|---|---|
| | composition | | | |
| | 1 | 2 | 3 | 4 |
| Formulation | | | | |
| Thermoplastic resin: | | | | |
| COPE | 30 | 25 | 25 | |
| PP | | | | 15 |
| Elastomer component 1 | 70 | | 75 | |
| Elastomer component 2 | | 75 | | 85 |
| Vulcanization system: | | | | |
| Butane tetracarboxylic acid | 0.3 | | 0.32 | |
| Zinc white | | 0.75 | | 0.85 |
| Stearic acid | | 0.1 | | 0.11 |
| Brominated phenol resin | | 4.5 | | 5.1 |
| Volume fraction φ_{P} | 31.6 | 27.2 | 26.4 | 16.5 |
| φ_{R} | 68.4 | 72.8 | 73.6 | 83.5 |
| Melt viscosity η_{P} | 2900 | 2500 | 2900 | 2500 |
| η_{R} | 6500 | 6800 | 6800 | 6800 |
| α | 0.96 | 0.98 | 1.24 | 1.86 |

| Kneading situation | Normal | | Unkneadable |
|---|---|---|---|
| JIS hardness | 70 | 60 | Unmeasurable |

### Example 1

A wiper blade having the configuration as shown in FIG. 1 was produced in a continuous manner by using the resulting thermoplastic elastomer composition for the base and a steel ribbon having a cross section of 5 mm×0.7 mm for the reinforcement, and co-extruding these materials.

### Example 2

A wiper blade having the configuration as shown in FIG. 2 was produced in a continuous manner by using the thermoplastic elastomer composition 1 for the base and a steel ribbon having a cross section of 0.7 mm×2.0 mm for the reinforcement, and co-extruding these materials.

### Example 3

A wiper blade having the configuration as shown in FIG. 1 was produced by installing two extruders, and co-extruding the thermoplastic elastomer composition 1 and Nylon 6 reinforced with 20% glass fiber (CM1001G-20 manufactured by Toray Industries, Inc.) to continuously produce the wiper blade. The reinforcement comprising the glass fiber-reinforced Nylon 6 had a cross section of 1.0 mm×5.0 mm.

### Example 4

A wiper blade having the configuration as shown in FIG. 1 was produced in a continuous manner by using the thermoplastic elastomer composition 2 for the base and a steel ribbon having a cross section of 0.7 mm×5.0 mm for the reinforcement, and co-extruding these materials.

### Comparative Example 1

A wiper blade having the configuration as shown in FIG. 2 was produced by press molding a wiper blade from natural rubber (JIS A hardness, 60), treating the edge of the wiper blade with chlorine, and inserting two steel rods each having a cross section of 0.7 mm×2.0 mm in the wiper blade as a reinforcement.

### Comparative Example 2

A wiper blade having the configuration as shown in FIG. 1 was produced in a continuous manner by using COPE 1 for the base and a steel ribbon having a cross section of 0.7 mm×5.0 mm for the reinforcement, and co-extruding these materials.

<Evaluation of Wiper Blade>

The wiper blades produced as described above were cut into blades of 45 cm, and evaluated on a test car as described below. The results are shown in Table 3.

(1) Initial Wiping Performance

Initial wiping performance was evaluated immediately after the start of the test carried out in accordance with JIS D5710, and the sample which left no wiping inconsistency on the glass surface by the wiper blade was evaluated as ◯, the sample which left some wiping inconsistency was evaluated as Δ, and the sample which left a considerable amount of wiping inconsistency was evaluated as x.

(2) Long Term Durability

Durability was evaluated according to JIS D5710. The sample which endured the wiping of 750,000 reciprocating cycles or more with no abnormality was evaluated as ◯, 500,000 cycles or more and less than 750,000 cycles was evaluated as Δ, and less than 500,000 cycles was evaluated as x.

(3) Chattering Noise

The sample which generated chattering noise in the long term durability test was evaluated as x, and the sample which generated no chattering noise was evaluated as ◯.

(4) Number of Assembly Operations

By assuming the number of assembly operations in Comparative Example 1 as 100, the number of assembly operations in each Example and Comparative Example was expressed in terms of a relative value to that of Comparative Example 1.

TABLE 3

| | | | | | Comp. | Comp. |
|---|---|---|---|---|---|---|
| | Example 1 | Example 2 | Example 3 | Example 4 | Example 1 | Example 2 |
| Wiper blade | | | | | | |
| Base | | | | | | |
| Material | Thermo- | Thermo- | Thermo- | Thermo- | Chlorine- | COPE |
| | plastic | plastic | plastic | plastic | treated | |
| | elastomer | elastomer | elastomer | elastomer | NR | |
| | composi- | composi- | composi- | composi- | | |
| | tion 1 | tion 1 | tion 1 | tion 2 | | |
| JIS A hardness | 70 | 70 | 70 | 60 | 60 | 95 |
| Reinforcement | | | | | | |
| Material | Steel | Steel | N6/GF20 | Steel | Steel | Steel |
| Cross section | 0.7 × 5.0 mm | 0.7 × 2.0 mm | 1.0 × 5.0 mm | 0.7 × 5.0 mm | 0.7 × 2.0 mm | 0.7 × 5.0 mm |
| | | × 2 | | | × 2 | |
| Molding method | Co- | Co- | Co- | Co- | Compres- | Co- |
| | extrusion | extrusion | extrusion | extrusion | sion | extrusion |
| | | | | | molding | |
| Performance | | | | | | |
| Initial wiping performance | ∘ | ∘ | ∘ | ∘ | ∘ | x |
| Long term durability | ∘ | ∘ | ∘ | Δ | Δ | Δ |
| Chattering noise | ∘ | ∘ | ∘ | ∘ | ∘ | ∘ |
| No. of assembly operations | 40 | 40 | 40 | 40 | 100 | 40 |

As evident from the results shown in Table 3, the wiper blades of the present invention exhibit excellent initial wiping performance and the long term durability, suppressed chattering noise, and reduced number of assembly operations (Example 1 to 4). However, when a PP having a melting point of 150° C. was used for the continuous phase of the thermoplastic elastomer composition, the composition experienced wear and some decrease in the durability after long term use (Example 4).

In contrast, the wiper blade comprising the rubber and the reinforcement inserted in the rubber wherein surface of the rubber had been hardened by chlorine treatment (Comparative Example 1) was insufficient in the long term durability. Such wiper blade also suffered from increased number of assembly operations since the wiper blade can not be integrally molded and additional step of the chlorine treatment is required. The wire blade wherein the reinforcement has been embedded in the polyester thermoplastic elastomer (Comparative Example 2) exhibited poor initial wiping performance due to the hardness of the polyester thermoplastic elastomer, and inferior long term durability due to the poor durability of the polyester thermoplastic elastomer itself.

### Example 5

The deflection (the value of D shown in FIG. 11) measured for the wiper blade produced in Example 1, the deflection determined by calculation, the value K of the curving coefficient (calculated value) are shown in Table 4.

In addition, the result of the evaluation of the wiping performance (wiping inconsistency) for the wiper blade of 475 mm on Nissan Silvia manufactured in 1991 is shown in Table 4.

In Table 4, ◯designates that the area remained unwiped was 1 cm² or less, and x designates that the unwiped area was 2 cm² or more.

### Reference Example 1

A wiper blade was produced by repeating the procedure of Example 5 except that the reinforcement was replaced with the one having the same shape and size but made of a polyester thermoplastic elastomer (Pelprene P95C manufactured by Toyobo Co., Ltd.). The results are shown in Table 4.

### Reference Example 2

A wiper blade was produced by repeating the procedure of Example 5 except that the thickness of the steel ribbon was reduced to 0.4 mm. The results are shown in Table 4.

### Example 6

A wiper blade was produced by repeating the procedure of Example 5 except that the reinforcement was replaced with the one having a cross section of 6 mm×3.5 mm shown in FIG. 4(d) made of a thermoplastic resin (Pelprene P95C manufactured by Toyobo Co., Ltd.). The results are shown in Table 4.

### Example 7

A wiper blade was produced by repeating the procedure of Example 6 except that the base was replaced with the one made of the thermoplastic elastomer composition 2 shown in Table 2. The results are shown in Table 4.

TABLE 4

| | | Refer- | Refer- | | |
|---|---|---|---|---|---|
| | | ence | ence | | |
| | Ex. 5 | Ex. 1 | Ex. 2 | Ex. 6 | Ex. 7 |
| | Thermoplastic Elastomer | | | | Composi- |
| | Composition 1 | | | | tion 2 |
| | | Thermo- | | Thermo- | Thermo- |
| Base (Table 2) | | plastic | | plastic | plastic |
| Reinforcement | Steel | resin | Steel | resin | resin |
| (mm × mm) | (5 × 0.7) | (5 × 0.7) | (5 × 0.4) | (6 × 3.5) | (6 × 3.5) |
| E₁ (MPa) | 0.5 | 0.5 | 0.5 | 0.5 | 0.25 |
| h₁ (mm) | 9.3 | 9.3 | 9.6 | 6.5 | 6.5 |
| E₂ (MPa) | 200000 | 100 | 200000 | 100 | 100 |
| h₂ (mm) | 0.7 | 0.7 | 0.4 | 3.5 | 3.5 |
| ρ1 | 0.005 | 0.045 | 0.005 | 0.045 | 0.043 |
| ρ2 | 0.05 | 0.05 | 0.05 | 0.05 | 0.05 |
| m | 0.0000025 | 0.005 | 0.0000025 | 0.005 | 0.0025 |
| n | 13.28 | 13.28 | 24 | 1.857 | 1.857 |
| δρ | 0.045 | 0.005 | 0.045 | 0.005 | 0.007 |
| Curving | 8.9 × 10⁻⁴ | 3.8 × 10⁻³ | 4.4 × 10⁻³ | 9.0 × 10⁻⁴ | 7.0 × 10⁻⁴ |
| coefficient K | | | | | |
| D (mm) | 5.56 | 23.8 | 27.5 | 5.63 | 4.38 |
| (calculated | | | | | |
| value) | | | | | |
| D (mm) | 10 | 25 | 25 | 8 | 8 |
| (measured | | | | | |
| value) | | | | | |
| Evaluation | ∘ | x | x | ∘ | ∘ |
| of wiping | | | | | |
| performance | | | | | |

<Preparation of Thermoplastic Elastomer Composition 4 for Surface Coating Layer>

Thermoplastic elastomer composition 4 for surface coating layer was produced as in the case of the thermoplastic elastomer composition of Table 2 except for the use of 45 parts by weight of COPE shown in Table 2; 55 parts by weight of elastomer component prepared as in the case of the elastomer compound 1 of Table 1 except for the use of 30 parts by weight of silica (Nipsil AQ manufactured by Nippon Silica) instead of 40 parts by weight of the carbon; 0.45 parts by weight of the vulcanization system (butane tetracarboxylic acid: BTC manufactured by Mitsui Toatsu Fine Chemicals Inc.); and 5 parts by weight of the pigment (PER(F)502 red manufactured by Toyobo Co., Ltd.). The thermoplastic elastomer composition 4 had a hardness (JIS-A) of 90.

Composition of thermoplastic elastomer composition 4

| | |
|---|---|
| Polyester thermoplastic elastomer (COPE): | 45 parts by weight |
| The elastomer components as described below: | 55 parts by weight |
| ACM: | 100 parts by weight |
| Silica: | 30 parts by weight |
| DOP: | 10 parts by weight |
| Antiaging agent: | 2 parts by weight |
| Processing aid: | 2 parts by weight |
| Vulcanization system (BTC): | 0.45 parts by weight |
| Coloring pigment: | 5 parts by weight |

<Production of Wiper Blade Having Surface Coating Layer>

### Example 8

A wiper blade having the configuration of FIG. 12 was produced by co-extrusion using two resin extruders under the temperature condition of 240° C., and by using the thermoplastic elastomer composition 1 (hardness 70) shown in Table 2 for the body base and the thermoplastic elastomer composition 4 (hardness 90) for the surface coating layer. The surface coating layer had a thickness of 50 μm.

### Example 9

A wiper blade having the configuration of FIG. 13 was produced by co-extrusion using two resin extruders under the temperature condition of 240° C., and by using the thermoplastic elastomer composition 1 shown in Table 2 for the body base and the thermoplastic elastomer composition 4 for the surface coating layer. The surface coating layer had a thickness of 30 μm.

### Example 10

A wiper blade having the configuration of FIG. 13 was produced by co-extrusion using two resin extruders under the temperature condition of 240° C., and by using the thermoplastic elastomer composition 1 shown in Table 2 for the body base and COPE for the surface coating layer. The surface coating layer had a thickness of 30 μm.

### Example 11

A wiper blade having the configuration of FIG. 13 was produced by co-extrusion using two resin extruders under the temperature condition of 240° C., and by using the thermoplastic elastomer composition 3 (hardness 60) shown in Table 2 for the body base and PP for the surface coating layer. The surface coating layer had a thickness of 30 μm.

### Example 12

A wiper blade having the configuration of FIG. 14 was produced using two resin extruders under the temperature condition of 240° C., and by using the thermoplastic elastomer composition 1 shown in Table 2 for the body base, the thermoplastic elastomer composition 4 for the surface coating layer, and the steel ribbon for the reinforcement, and co-extruding these materials to continuously produce the wiper blade. The surface coating layer had a thickness of 30 μm.

### Example 13

A wiper blade having the configuration of FIG. 12 was produced by co-extrusion using two resin extruders under the temperature condition of 240° C., and by using the thermoplastic elastomer composition 3 shown in Table 2 for the body base and the thermoplastic elastomer composition 4 for the surface coating layer. The surface coating layer had a thickness of 30 μm.

### Comparative Example 3

A wiper blade having no surface coating layer was produced by co-extrusion using COPE for the body base.

### Comparative Example 4

A wiper blade was produced by press molding the body from a natural rubber and treating the surface with chlorine.

The wiper blades produced as described above were cut into blades of 45 cm, and evaluated on a test car as described below. The results are shown in Table 5.

<Long Term Durability>

Durability was evaluated according to JIS D5710. The sample which endured wiping of 750,000 cycles or more with no abnormality was evaluated as ◯, 500,000 cycles or more and less than 750,000 cycles was evaluated as Δ, and less than 500,000 cycles was evaluated as x.

<Chattering Noise>

The sample which generated chattering noise in the long term durability test was evaluated as x, and the sample which generated no chattering noise was evaluated as ◯.

<Initial Wiping Performance>

Initial wiping performance was evaluated by visual inspection after first several cycles in the long term durability test, and the sample which left a considerable amount of wiping inconsistency on the glass surface by the wiper blade was evaluated as, the sample which left some wiping inconsistency was evaluated as Δ, and the sample which left no wiping inconsistency was evaluated as ◯.

TABLE 5

| | | | Initial |
|---|---|---|---|
| | Long term | Chattering | wiping |
| | durability | noise | performance |
| Example 8 | ∘ | ∘ | ∘ |
| Example 9 | ∘ | ∘ | ∘ |
| Example 10 | ∘ | ∘ | Δ |
| Example 11 | Δ | ∘ | Δ |
| Example 12 | ∘ | ∘ | ∘ |
| Example 13 | Δ | ∘ | ∘ |
| Comparative | Δ | ∘ | x |
| Example 3 | | | |
| Comparative | Δ | ∘ | ∘ |
| Example 4 | | | |

As evident from the results shown in Table 5, the wiper blades of the present invention exhibited excellent long term durability, suppressed chattering noise, and improved initial wiping performance (Examples 8 to 13).

The surface coating layer of the wiper blades of Examples 9, 10 and 12 became abraded in the long term durability test after 650,000 reciprocating cycles, and the body became exposed. In the case of Example 11, the body became exposed at 400,000 cycles. The exposure of the body was easily noticed due to the color difference between the body and the surface coating layer.

The wiper blade production method of Example 10 enjoyed less number of production steps.

<Preparation of Edge Material>

The material used for the edge was prepared by blending the material at the blend ratio shown in Table 6 by the procedure similar to the material used for the body described in the <Preparation of thermoplastic elastomer composition>. The starting materials used for the edge material are as described below.

(1) Base

(1) Polyester thermoplastic elastomer (COPE (JIS A 95)): Pelprene P95C

(2) Polyester thermoplastic elastomer (COPE (JIS A 70)): Pelprene P30B manufactured by Toyobo Co., Ltd.; JIS-A hardness, 70; melting point, 160° C.

(3) Thermoplastic elastomer composition (COPE/ACM): the thermoplastic elastomer composition the same as the one used for the body 1

(4) Polypropyrene (PP): RB121D

(5) Urethane coating: polymer (30 mass %)/solvent (70 mass %)

(2) Lubricating Filler

(1) Graphite: OS carbon powder FA4 manufactured by Oriental Kogyo; average particle size, 4 μm

(2) PTFE powder: Hostaflon TF9207 manufactured by 3M; average particle size, 4 μm

(3) Glass beads: EMB-10 manufactured by Toshiba Microbeads; average particle size, 5 μm

(4) Glass balloons: Scotchlite S60/1000 manufactured by 3M; average particle size, 70 μm

TABLE 6

| | Edge | Edge | Edge | Edge | Edge | Edge | Edge | Edge | Edge | Edge | Edge | Edge | Edge |
|---|---|---|---|---|---|---|---|---|---|---|---|---|---|
| | 0 | 1 | 2 | 3 | 4 | 5 | 6 | 7 | 8 | 9 | 10 | 11 | 12 |
| Base | | | | | | | | | | | | | |
| COPE(JIS A95) | 100 | 100 | 100 | 100 | 100 | 100 | 100 | 100 | 100 | | | | |
| COPE(JIS A70) | | | | | | | | | | 100 | | | |
| COPE/ACM | | | | | | | | | | | 100 | | |
| PP | | | | | | | | | | | | 100 | |
| Urethane coating | | | | | | | | | | | | | 100 |
| Lubricating filler | | | | | | | | | | | | | |
| Graphite | 0 | 3.7 | 9.5 | 45.3 | 167.1 | 271.5 | | | | 45.3 | 45.3 | 58.3 | 14.3 |
| PTFE powder | | | | | | | 45.3 | | | | | | |
| Glass beads | | | | | | | | 56 | | | | | |
| Glass balloon | | | | | | | | | 56 | | | | |
| Filler (vol %) | 0 | 2 | 5 | 20 | 48 | 60 | 20 | 20 | 20 | 20 | 20 | 20 | 20 |
| | | | | | | Not | | | | | | | |
| | | | | | | knead- | | | | | | | |
| | | | | | | able | | | | | | | |

<Production of Wiper Blade Having an Edge>

Reference Example 3 and Examples 14 to 22 and 24

A wiper blade was produced by co-extrusion using two resin extruders under the temperature condition of 240° C., and by using the materials for the body (base) and the edge shown in Table 6.

### Example 23

A wiper blade was produced by extrusion using the material for the body (base) shown in Table 6, and the material for the edge shown in Table 6 was coated on the surface of the edge.

### Conventional Example 1

A body was press molded from natural rubber, and the surface was treated with chlorine to produce the wiper blade.

<Evaluation of Wiper Blade>

(1) Frictional Coefficient

The samples produced as described above (size, 20 mm×40 mm; thickness 2 mm) were evaluated for their frictional coefficient by placing the sample on a glass plate and pulling the sample at room temperature under the load of 100 g and at a pulling speed of 100 mm/min.

(2) Wiping Properties of the Wiper

The wiper blades produced as described above were cut into blades of 45 cm, and mounted on a test car. Durability test was conducted according to JIS D5710. Wiping performance was evaluated by visual inspection after first several cycles in the long term durability test, and the sample which left a considerable amount of wiping inconsistency on the glass surface by the wiper blade was evaluated as x, the sample which left some wiping inconsistency was evaluated as Δ, and the sample which left no wiping inconsistency was evaluated as ◯.

(3) Wiper Chattering (Occurrence of Chattering)

The wiper blades produced as described above were cut into blades of 45 cm, and mounted on a test car. Durability was test was conducted according to JIS D5710. Occurrence of the chattering of the wiper blade was evaluated by visual inspection during 1 minute period after stopping the water supply in the durability test.

(4) Durability

The wiper blades produced as described above were cut into blades of 45 cm, and evaluated on a test car, and durability was evaluated according to JIS D5710. The sample which endured wiping of 750,000 cycles or more with no abnormality was evaluated as ◯, 500,000 cycles or more and less than 750,000 cycles was evaluated as Δ, and less than 500,000 cycles was evaluated as x.

(5) Number of Processing Operations

By assuming the number of processing operations in Conventional Example 1 as 100%, the number of processing operations in each Example and Comparative Example was expressed in terms of a relative value to the number of processing operations of Conventional Example 1.

(6) Ten Point Average Roughness (R_{z})

The surface of the edge of the wiper blades produced as described above which becomes in contact with the glass was measured for its surface roughness in accordance with JIS B0601-1994 by using a surface roughness tester (probe type) to thereby determine the ten point average roughness (R_{z}).

(7) Hardness Ratio of the Body to the Edge

The material used for the body and the material used for the edge were respectively measured for their hardness (JIS-A), and their hardness ratio was calculated. The measurement of the hardness (JIS-A) was conducted in accordance with JIS K6253 by molding the material in the form of a plate having a thickness of 2 mm, and placing three plates on one another.

The results are shown in Table 7.

The wiper blades of Examples 14 to 22 and 24 according to the present invention exhibits low frictional coefficient since the lubricating filler has been incorporated in the edge material as evident from the comparison with the Reference Example 3. Similar effects are realized by coating the edge surface with a filler as confirmed from the Example 23.

It is also evident from the comparison of the Example 14 to 24 with the Conventional Example 1 that the wiper blade of the invention has wiping performance equivalent to that of the conventional wiper blade.

Comparison of the Example 14 to 24 with the Conventional Example 1 also reveals that the number of production operations is reduced in the present invention to constitute another characteristic feature of the present invention.

TABLE 7

| | | | | | | | | | | | | Ex. | |
|---|---|---|---|---|---|---|---|---|---|---|---|---|---|
| | Ref. | Ex. | Ex. | Ex. | Ex. | Ex. | Ex. | Ex. | Ex. | Ex. | Ex. | 24 | |
| | Ex. 3 | 14 | 15 | 16 | 17 | 18 | 19 | 20 | 21 | 22 | 23 | Body | |
| | Body 1 | | | | | | | | | | | 2 | Conv. |
| | | | | | | | | | | | Edge | Edge | Ex. 1 |
| Structure | | | | | | | | | | | 12 | 11 | Natural |
| Body material | Edge | Edge | Edge | Edge | Edge | Edge | Edge | Edge | Edge | Edge | Co-ex- | Co- | Rubber |
| Edge material | 0 | 1 | 2 | 3 | 4 | 6 | 7 | 8 | 9 | 10 | trusion, | ex- | Pressing, |
| Production Method | Co-extrusion | | | | | | | | | | coating | trusion | C1 |
| Wiper Properties | | | | | | | | | | | | | |
| Friction coeff. | 10.1 | 2.1 | 1.2 | 0.7 | 0.6 | 1.2 | 1 | 0.9 | 0.7 | 0.7 | 0.7 | 0.7 | 1.2 |
| Chattering noise | Yes | No | No | No | No | No | No | No | No | No | No | No | No |
| Wiping performance | ∘ | ∘ | ∘ | ∘ | Δ | ∘ | ∘ | Δ | ∘ | ∘ | ∘ | ∘ | ∘ |
| Durability | x | Δ | ∘ | ∘ | ∘ | ∘ | ∘ | ∘ | ∘ | Δ | ∘ | ∘ | Δ |
| No. of processing | 20 | 20 | 20 | 20 | 20 | 20 | 20 | 20 | 20 | 20 | 70 | 20 | 100 |
| operations (%) | | | | | | | | | | | | | |
| Rz | 1.1 | 2.1 | 5.1 | 10.2 | 10.5 | 9.1 | 13.3 | 41.5 | 8.8 | 21.1 | 11.2 | 9.1 | 15.1 |
| Hardness ratio | 1.2 | 1.2 | 1.2 | 1.3 | 1.4 | 1.2 | 1.4 | 1.4 | 1.2 | 1.0 | 1.4 | 1.7 | — |

### INDUSTRIAL APPLICABILITY

The present invention has enabled to produce a wiper blade which meets the properties required for a wiper blade such as wiping performance, suppression of the chattering noise, and durability by integrally molding the base and the reinforcement. Production of a wire blade by simple process has been enabled, and a useful wiper blade as well as the production method are provided.

When the leading edge at the edge of the wiper blade of the present invention is coated with a surface coating layer, the surface coating layer may serve an indicator mark by forming the surface coating layer from a material having a color different from the body.

In the case of the wiper blade of the present invention having the edge, at least the surface of the edge which becomes in contact with the glass exhibits reduced friction with the glass, and as a consequence, chattering of the wiper blade caused by the friction with the glass is reduced without detracting the high durability and rubbing performance.

Even such wiper blade having a surface coating layer and an edge can be easily produced by a reduced number of production operations since the wiper blade is produced by co-extrusion.

1. A wiper blade produced by integrally molding a thermoplastic elastomer composition and a reinforcement, wherein the thermoplastic elastomer composition comprises a thermoplastic resin and a dynamically crosslinked elastomer component, and the thermoplastic elastomer composition has a structure wherein the dynamically crosslinked elastomer component is dispersed in a continuous phase of the thermoplastic resin.

2. A wiper blade according to claim 1 wherein said thermoplastic elastomer composition contains the thermoplastic resin and the elastomer component at a weight ratio (thermoplastic resin/elastomer component) of 85/15 to 15/85.

3. A wiper blade according to claim 1 or 2 wherein said thermoplastic resin has a melting point of 200° C. or higher.

4. A method for producing a wiper blade of to any one of claims 1 to 3 wherein said thermoplastic elastomer composition and said reinforcement are integrally molded by co-extrusion.

5. A wiper blade which is an integrally molded article comprising a base made of a thermoplastic elastomer composition and a reinforcement, and which satisfies the following characteristics (1) and (2):
(1) when said thermoplastic elastomer composition and said reinforcement has a Young's modulus of E₁ and E₂, respectively; difference in shrinkage between the material used for said thermoplastic elastomer composition and said reinforcement is δᵣ; and said wiper blade is regarded as a bilayer structure substantially comprising a base layer of the thermoplastic elastomer composition and a reinforcement layer,
curving coefficient K determined by the following formula is up to 1×10⁻³
K=2δᵣ/[3+{(1+mn)(1+mn³)/mn(1+n)²}] (i)
wherein
δᵣ represents difference in the shrinkage between the base and the reinforcement;
m represents E₁/E₂ (wherein E₁ is Young's modulus of the base, and E₂ is Young's modulus of the reinforcement); and
n represents h₁/h₂ (wherein h₁ is thickness of the base, and h₂ is thickness of the reinforcement); and
(2) when the wiper blade has a length of 200 mm and a concentrated load of 50 g is placed at one end, the wiper blade exhibits a distortion in the range of 20 to 80 mm.

6. A wiper blade according to claim 5 wherein said thermoplastic elastomer composition comprises a thermoplastic resin and a dynamically crosslinked elastomer component, and said thermoplastic elastomer composition has a structure wherein the dynamically crosslinked elastomer component is dispersed in a continuous phase of the thermoplastic resin.

7. A method for producing the wiper blade of claim 5 or 6 wherein the thermoplastic elastomer composition and the reinforcement that have been selected to satisfy the (1) and the (2) are integrally molded by co-extrusion.

8. A wiper blade comprising a body and a surface coating layer which covers at least edge surface of said body, wherein
at least said body comprises a thermoplastic elastomer composition which comprises a thermoplastic resin and a dynamically crosslinked elastomer component, and which has a structure wherein the dynamically crosslinked elastomer component is dispersed in a continuous phase of the thermoplastic resin.

9. A wiper blade according to claim 8 wherein said surface coating layer has a melting point of 200° C. or higher.

10. A wiper blade according to claim 8 or 9 wherein said surface coating layer comprises a thermoplastic elastomer composition which comprises a thermoplastic resin and a dynamically crosslinked elastomer component, and which has a structure wherein the dynamically crosslinked elastomer component is dispersed in a continuous phase of the thermoplastic resin.

11. A wiper blade according to any one of claims 8 to 10 wherein said body has a hardness (JIS-A) of 50 to 80, and said surface coating layer has a hardness (JIS-A) of 70 to 99.

12. A method for producing a wiper blade of any one of claims 8 to 11 wherein the materials used for said body and the material used for said surface coating layer are integrally molded by co-extrusion.

13. A wiper blade comprising at least a body made of a thermoplastic elastomer composition and an edge made of a thermoplastic elastomer composition or a thermoplastic resin wherein at least the surface of said edge which becomes in contact with glass has a ten point average roughness of 2 to 50 μm.

14. A wiper blade according to claim 14 wherein at least the part of said edge which becomes in contact with glass comprises a material containing 3 to 50 vol % of a filler having an average particle size of up to 40 μm.

15. A wiper blade according to claim 14 wherein said filler is graphite, molybdenum disulfide, polyethylene tetrafluoride, or glass beads.

16. A wiper blade according to any one of claims 13 to 15 wherein said body comprises a thermoplastic elastomer composition which comprises a thermoplastic resin and a dynamically crosslinked elastomer component, and which has a structure wherein the dynamically crosslinked elastomer component is dispersed in a continuous phase of the thermoplastic resin.

17. A wiper blade according to any one of claims 13 to 16 wherein said edge comprises a thermoplastic elastomer composition which comprises a thermoplastic resin and a dynamically crosslinked elastomer component, and which has a structure wherein the dynamically crosslinked elastomer component is dispersed in a continuous phase of the thermoplastic resin.

18. A wiper blade according to any one of claims 13 to 17 produced by co-extruding the material of said body and the material of said edge.
